(19) United States
(12) Patent Application Publication
(10) Pub. No.: US 2024/0371272 A1
(43) Pub. Date: Nov. 7, 2024

(54) VEHICLE CONTROL DEVICE AND VEHICLE CONTROL METHOD

(71) Applicant: DENSO CORPORATION, Kariya-city (JP)

(72) Inventors: Takuya KUME, Kariya-city (JP); Kazuki IZUMI, Kariya-city (JP)

(21) Appl. No.: 18/774,722

(22) Filed: Jul. 16, 2024

Related U.S. Application Data
(63) Continuation of application No. PCT/JP2022/047209, filed on Dec. 21, 2022.

(30) Foreign Application Priority Data
Jan. 31, 2022 (JP) 2022-012733
Dec. 14, 2022 (JP) 2022-199673

(51) Int. Cl. G08G 1/16; B60W 50/14; G06V 20/58

(52) U.S. Cl. CPC G08G 1/167; B60W 50/14; G06V 20/58; B60W 2050/146

(57) ABSTRACT

A vehicle control device in a vehicle performing autonomous driving without monitoring responsibility is provided. The vehicle control device is configured to identify a situation of the vehicle and make a notification to the inside of a compartment of the vehicle. The vehicle control device identifies, as the situation of the vehicle, a first waiting situation where an automatic lane change which was started has to be interrupted in the middle and waited during the autonomous driving without monitoring responsibility. In a case where the first waiting situation is identified, the vehicle control device makes a notification to notify of a waiting state in which the vehicle interrupts the lane change in the middle and is waiting.

### CROSS-REFERENCE TO RELATED APPLICATION

The present application is a continuation application of International Patent Application No. PCT/JP2022/047209 filed on Dec. 21, 2022 which designated the U.S. and claims the benefit of priorities from Japanese Patent Application No. 2022-012733 filed on Jan. 31, 2022 and Japanese Patent Application No. 2022-199673 filed on Dec. 14, 2022. The entire disclosures of all of the above applications are incorporated herein by reference.

### TECHNICAL FIELD

The present disclosure relates to a vehicle control device and a vehicle control method.

### BACKGROUND

A rerated art discloses a technique of making a host vehicle autonomously travel by automatically operating driving operation devices such as a throttle actuator, a brake actuator, a shift positioner, a steering, and an indicator. A related art discloses a technique, when it is determined that there is no lane in which a host vehicle can continuously travel along a road at the time of autonomous driving, performing control to change the lane toward a lane which is not along the road.

### SUMMARY

The present disclosure provides a vehicle control device in a vehicle performing autonomous driving without monitoring responsibility. The vehicle control device is configured to identify a situation of the vehicle and make a notification to the inside of a compartment of the vehicle. The vehicle control device identifies, as the situation of the vehicle, a first waiting situation where an automatic lane change which was started has to be interrupted in the middle and waited during the autonomous driving without monitoring responsibility. In a case where the first waiting situation is identified, the vehicle control device makes a notification to notify of a waiting state in which the vehicle interrupts the lane change in the middle and is waiting.

### BRIEF DESCRIPTION OF THE DRAWINGS

Objects, features and advantages of the present disclosure will become more apparent from the following detailed description made with reference to the accompanying drawings. In the drawings:

FIG. 1 is a diagram illustrating an example of a schematic configuration of a system for a vehicle;

FIG. 2 is a diagram illustrating an example of a schematic configuration of an autonomous driving ECU;

FIG. 3 is a diagram for explaining an example of a surrounding situation image;

FIG. 4 is a diagram for explaining an example of a surrounding situation image;

FIG. 5 is a diagram for explaining an example of a surrounding situation image;

FIG. 6 is a diagram illustrating an end timing of a waiting cause notification;

FIG. 7 is a flowchart illustrating an example of the flow of LC waiting related process in the autonomous driving ECU;

FIG. 8 is a diagram illustrating an example of a schematic configuration of an autonomous driving ECU;

FIG. 9 is a flowchart illustrating an example of the flow of the LC waiting related process in the autonomous driving ECU;

FIG. 10 is a diagram illustrating an example of a schematic configuration of a system for a vehicle;

FIG. 11 is a diagram illustrating an example of a schematic configuration of an autonomous driving ECU;

FIG. 12 is a flowchart illustrating an example of the flow of timeout related notifying process in the autonomous driving ECU;

FIG. 13 is a diagram illustrating an example of a schematic configuration of a system for a vehicle;

FIG. 14 is a diagram illustrating an example of a schematic configuration of an autonomous driving ECU;

FIG. 15 is a flowchart illustrating an example of the flow of second task related process in the autonomous driving ECU;

FIG. 16 is a diagram illustrating an example of a schematic configuration of a system for a vehicle;

FIG. 17 is a diagram illustrating an example of a schematic configuration of an autonomous driving ECU;

FIG. 18 is a flowchart illustrating an example of the flow of setting change related process in the autonomous driving ECU;

FIG. 19 is a diagram illustrating an example of a schematic configuration of a system for a vehicle;

FIG. 20 is a diagram illustrating an example of a schematic configuration of an autonomous driving ECU; and

FIG. 21 is a flowchart illustrating an example of the flow of passing waiting related process in the autonomous driving ECU.

### DETAILED DESCRIPTION

As automation levels of autonomous driving, for example, automation levels classified to the levels 0 to 5 defined by SAE are known. Level 0 is a level at which a driver executes all driving tasks without intervention of a system. Level 0 corresponds to so-called manual driving. Level 1 is a level at which the system supports steering or acceleration/deceleration. Level 2 is a level at which the system assists both steering and acceleration/deceleration. The autonomous driving at Levels 1 and 2 is autonomous driving in which the driver has responsibility of monitoring related to safety driving (hereinafter, simply monitoring responsibility). Level 3 is a level at which the system can execute all of the driving tasks in a specific place such as a highway, and the driver performs the driving operation in an emergency. Level 4 is a level at which the system can execute all of the driving tasks except under particular situations such as roads which cannot be handled, extreme environment, and the like. Level 5 is a level at which the system can execute all of the driving tasks under every environment. The autonomous driving at Level 3 or higher is autonomous driving with no monitoring responsibility for the driver.

In the case of trying the lane change as disclosed in the related art during autonomous driving without monitoring responsibility to the driver (hereinafter, autonomous driving without monitoring responsibility), it is considered that the system side of a vehicle determines whether a lane change is possible, and the lane change starts. In this case, there is the possibility that, after the lane change starts, the lane change cannot be completed due to rapid approach of another vehicle, and the vehicle remains in a waiting state during the lane change. During the autonomous driving without monitoring responsibility, the possibility that the driver does not grasp the situation around the host vehicle is high. Therefore, when the lane change waiting state occurs after the lane change starts, the driver cannot grasp the situation and may have strange feeling.

The present disclosure provides a vehicle control device and a vehicle control method, capable of reducing a feeling of strangeness given to the driver even when a lane change has to be waited during an automatic lane change in autonomous driving without monitoring responsibility.

According to one aspect of the present disclosure, a vehicle control device, which can be used in a vehicle performing autonomous driving without monitoring responsibility as autonomous driving without surrounding monitoring responsibility is provided. The vehicle control device includes: a situation identifying unit that is configured to identify a situation of the vehicle; and a notification control unit that is configured to make a notification to inside of a compartment of the vehicle. The situation identifying unit identifies, as the situation of the vehicle, a first waiting situation where an automatic lane change which was started has to be interrupted in middle and waited during the autonomous driving without monitoring responsibility. In a case where the situation identifying unit identifies the first waiting situation, the notification control unit makes a notification to notify of a waiting state in which the vehicle interrupts the lane change in the middle and is waiting, and a notification to notify of a cause of the waiting state.

According to one aspect of the present disclosure, a vehicle control method, which can be used in a vehicle executing autonomous driving without monitoring responsibility as autonomous driving without surrounding monitoring responsibility, is provided. The vehicle control methods includes: a situation identifying step of identifying a situation of the vehicle; and a notification control step of making a notification to the inside of a compartment of the vehicle. The steps are executed by at least one processor. In the situation identifying step, a first waiting situation where an automatic lane change which was started has to be interrupted in the middle and waited during the autonomous driving without monitoring responsibility is identified as the situation of the vehicle. In the notification control step, in the case where the first waiting situation is identified in the situation identifying step, a notification to notify of a waiting state in which the vehicle interrupts the lane change in the middle and is waiting, and a notification to notify of the cause of the waiting state are made.

With the above configuration, in the case where the first waiting situation in which after an automatic lane change starts, the lane change is interrupted in the middle and the vehicle has to wait occurs during autonomous driving without monitoring responsibility, a notification to notify of a waiting state that the vehicle interrupted the lane change in the middle and is waiting and a notification to notify of the cause of the waiting state are made to the inside of the compartment of the vehicle. Therefore, even when the driver does not grasp the situation around the host vehicle during autonomous driving without monitoring responsibility, the driver can grasp the waiting state more easily. As a result, it is possible to reduce a feeling of strangeness given to the driver even when a lane change has to be waited during an automatic lane change in autonomous driving without monitoring responsibility.

A plurality of embodiments will be described with reference to the drawings. For convenience of description, any part functioning identically to a part depicted in any figure having been referred to in foregoing description will be denoted by an identical reference symbol and may not be described repeatedly in the following embodiments. For the elements denoted by the same reference symbols, the description thereof may be referred to in other embodiments.

### First Embodiment

### (Schematic Configuration of System 1 for Vehicle)

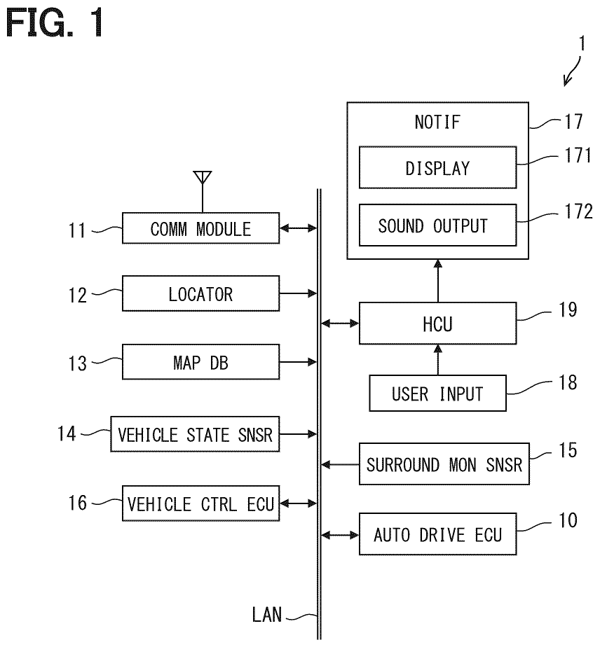

Hereinafter, a first embodiment of the present disclosure will be described with reference to the drawings. A system 1 for a vehicle illustrated in FIG. 1 can be used in a vehicle capable of autonomous driving (hereinafter, an autonomous driving vehicle). As illustrated in FIG. 1, the system 1 for a vehicle includes an autonomous driving ECU 10, a communication module 11, a locator 12, a map database (hereinafter, map DB) 13, a vehicle state sensor 14, a surrounding monitoring sensor 15, a vehicle control ECU 16, a notifying device 17, a user input device 18, and an HCU (Human Machine Interface Control Unit) 19. For example, the autonomous driving ECU 10, the communication module 11, the locator 12, the map DB 13, the vehicle state sensor 14, the surrounding monitoring sensor 15, the vehicle control ECU 16, and the HCU 19 may be connected to an in-vehicle LAN (refer to LAN in FIG. 1). A vehicle using the system 1 for a vehicle is not always limited to an automobile. In the following, however, the case of using the system for an automobile will be described as an example.

As levels of autonomous driving (hereinafter, automation levels) of an autonomous driving vehicle, for example, as the SAE defines, a plurality of levels can exist. The automation level is classified to, for example, LV0 to LV5 as follows.

LV0 is a level at which a driver executes all of driving tasks without intervention of the system. The driving tasks may be also called dynamic driving tasks. The driving tasks are, for example, steering, acceleration/deceleration, and surrounding monitoring. LV0 corresponds to so-called manual driving. LV1 is a level at which the system assists either steering or acceleration/deceleration. LV1 corresponds to so-called driving assistance. LV2 is a level at which the system assists both steering and acceleration/deceleration. LV2 corresponds to so-called partial driving automation. It is assumed that both LV1 and LV2 are a part of autonomous driving.

For example, the autonomous driving of LV1 and LV2 are autonomous driving in which the driver has monitoring responsibility for safety driving (hereinafter, simply, monitoring responsibility). That is, it corresponds to autonomous driving with monitoring responsibility. The driving of LV0 to LV2 corresponds to driving with monitoring responsibility. The monitoring responsibility includes visual surrounding monitoring. The autonomous driving of LV1 and LV2 can be also called autonomous driving which does not allow a second task. A second task is an action other than driving, which is allowed to the driver and is a predetermined specific action. The second tasks can be also called secondary activities, other activities, and the like. It is determined that the second task should not hinder the driver from responding to a driving operation takeover request from the autonomous driving system. As examples of the second tasks, viewing of content such as video, operation of a smartphone or the like, reading, eating, and the like are assumed.

The autonomous driving of LV3 is a level at which the system can execute all of the driving tasks under specific conditions and the driver performs the driving operation in an emergency. In the autonomous driving of LV3, when there is a driving takeover request from the system, the driver is required to promptly react to it. The driving takeover can be also called devolution of the surrounding monitoring responsibility from the system on the vehicle side to the driver. LV3 corresponds to so-called conditional driving automation. As LV3, there is area-limited LV3 which is limited to a specific area. The specific area in this case may be a highway. The specific area may be also, for example, a specific lane. LV3 also includes traffic-congestion-limited LV3 which is limited to the time of traffic congestion. The traffic-congestion-limited LV3 may be limited to, for example, the time of traffic congestion on a highway. A highway may include a car-dedicated road.

The autonomous driving of LV4 is a level the system can execute all of driving tasks except for specific situations such as roads which cannot be handled, extreme environment, and the like. LV4 corresponds to so-called high driving automation. The autonomous driving of LV5 is a level the system can execute all of the driving tasks under every environment. LV5 corresponds to so-called full driving automation. It is sufficient to make the autonomous driving of LV4 and LV5 executable, for example, in a travel section for which high-precision map data is prepared. The high-precision map data will be described later.

For example, it is assumed that the autonomous driving of LV3 to LV5 is autonomous driving in which the driver does not have monitoring responsibility. That is, it corresponds to autonomous driving without monitoring responsibility. The autonomous driving of the levels LV3 to LV5 can be also called autonomous driving which allows second tasks. It is assumed that the automation levels of the autonomous driving vehicle of the embodiment can be switched. The automation level may be switched only between levels as a part of LV0 to LV5. It is assumed that the autonomous driving vehicle of the embodiment can execute at least autonomous driving with surrounding monitoring responsibility.

The communication module 11 transmits/receives information to/from a center on the outside of the host vehicle via wireless communication. That is, wide area communication is performed. The communication module 11 receives traffic congestion information or the like from the center by wide area communication. The communication module 11 may transmit/receive information to/from another vehicle via wireless communication. That is, vehicle-to-vehicle communication may be performed. The communication module 11 may transmit/receive information to/from a roadside device mounted on the road side via wireless communication. That is, vehicle roadside communication may be performed. In the case of performing vehicle roadside communication, the communication module 11 may receive information of a surrounding vehicle transmitted from a vehicle surround the host vehicle via a roadside device. The communication module 11 may receive information of a surrounding vehicle transmitted from the vehicle near the host vehicle via the center.

The locator 12 has a GNSS (Global Navigation Satellite system) receiver and an inertial sensor. The GNSS receiver receives positioning signals from a plurality of positioning satellites. The inertial sensor has, for example, a gyroscope sensor and an acceleration sensor. The locator 12 sequentially measures the position of a host vehicle (hereinafter, host vehicle position) in which the locator 12 is mounted by combining the positioning signals received by the GNSS receiver and a result of measurement of the inertial sensor. It is sufficient that the host vehicle position is expressed by, for example, coordinates of latitude and longitude. Alternatively, for measuring the host vehicle position, a travel distance obtained from signals sequentially output from a vehicle speed sensor mounted in the host vehicle may be also used.

The map DB 13 is a nonvolatile memory and stores high-precision map data. The precision of the high-precision map data is higher than that of map data used for route guide in the navigation function. In the map DB 13, map data used for route guide may be also stored. The high-precision map data includes information which can be used for autonomous driving such as, for example, three-dimensional shape information of roads, information of the number of lanes, and information indicating the travel direction permitted to each lane. In addition, the high-precision map data may include, for example, information of node points indicating positions of both ends of a pavement mark such as a compartment line. The locator 12 may have a configuration which does not use a GNSS receiver by using three-dimensional shape information of roads. For example, the locator 12 may identify the host vehicle position by using three-dimensional shape information of roads and a result of detection by the surrounding monitoring sensor 15 such as LIDAR (Light Detection and Ranging/Laser Imaging Detection and Ranging) detecting a group of characteristic points of a road shape and a structural object or a surrounding monitoring camera. The three-dimensional shape information of roads may be generated on the basis of captured images by REM (Road Experience Management).

Map data distributed from an external server may be received by wide area communication via the communication module 11 and stored in the map DB 13. In this case, another configuration may be employed that a volatile memory is used as the map DB 13 and the communication module 11 sequentially obtains map data of a region corresponding to the host vehicle position.

The vehicle state sensor 14 is made by a sensor group for detecting various states of the host vehicle. As the vehicle state sensor 14, there are a vehicle speed sensor, a steering torque sensor, an accelerator sensor, a brake sensor, and the like. The vehicle speed sensor detects the speed of the host vehicle. The steering torque sensor detects a steering torque applied to a steering wheel. The accelerator sensor detects whether the accelerator pedal is pressed or not. As the accelerator sensor, an accelerator pedal force sensor detecting pedal force applied to the accelerator pedal may be used. As the accelerator sensor, an accelerator stroke sensor detecting an amount of stroke on the accelerator pedal may be used. As the accelerator sensor, an accelerator switch outputting a signal according to the presence/absence of an operation of pressing the accelerator pedal may be used. The brake sensor detects the presence/absence of a force on a brake pedal. As the brake sensor, a brake pedal force sensor detecting a pedal force applied to the brake pedal may be used. As the brake sensor, a brake stroke sensor detecting an amount of stroke on the brake pedal may be used. As the brake sensor, a brake switch outputting a signal according to the presence/absence of an operation of pressing the brake pedal may be used. The vehicle state sensor 14 outputs detected sensing information to an in-vehicle LAN. The sensing information detected by the vehicle state sensor 14 may be output to the in-vehicle LAN via an ECU mounted in the host vehicle.

The surrounding monitoring sensor 15 monitors the environment surrounding the host vehicle. As an example, the surrounding monitoring sensor 15 detects hindrances around the host vehicle, which are a moving object such as a pedestrian or another vehicle and a stationary object such as an object dropped on a road. In addition, the surrounding monitoring sensor 15 detects pavement marks such as travel compartment lines around the host vehicle. The surrounding monitoring sensor 15 is, for example, a sensor such as a surrounding monitoring camera capturing an image in a predetermined range around the host vehicle, and a millimeter-wave radar, a sonar, a LIDAR transmitting search waves to a predetermined range around the host vehicle. The predetermined range may be a range including at least parts of the front, rear, right and left of the host vehicle. The surrounding monitoring camera sequentially outputs images sequentially captured as sensing information to the autonomous driving ECU 10. The sensor transmitting search waves such as a sonar, a millimeter-wave radar, a LIDAR, or the like sequentially outputs scan results based on reception signals obtained in the case of receiving waves reflected by a hindrance as sensing information to the autonomous driving ECU 10. The sensing information detected by the surrounding monitoring sensor 15 may be output to the autonomous driving ECU 10 not through the in-vehicle LAN.

The vehicle control ECU 16 is an electronic control unit performing travel control of the host vehicle. As the travel control, acceleration/deceleration control and/or steering control can be mentioned. As the vehicle control ECU 16, there are a steering ECU performing steering control, a power unit control ECU and a brake ECU performing acceleration/deceleration control, and the like The vehicle control ECU 16 performs travel control by outputting control signals to each of travel control devices such as an electronic control throttle, a brake actuator, an EPS (Electric Power Steering) motor, and the like mounted in the host vehicle.

The notifying device 17 is provided for the host vehicle and makes a notification to the inside of the compartment of the host vehicle. The notifying device 17 makes a notification in accordance with an instruction of the HCU 19. It is sufficient that the notifying device 17 makes a notification at least to the driver. The notifying device 17 may make a notification also to an occupant other than the driver. The notifying device 17 includes a display device 171 and a sound output device 172.

The display device 171 makes a notification by displaying information. As the display device 171, for example, a meter MID (Multi Information Display), a CID (Center Information Display), an HUD (Head-Up Display), or the like can be used. The meter MID is a display device provided in front of the driver's seat in the compartment of the host vehicle. As an example, the meter MID may be provided for a meter panel. The CID is a display device disposed in the center of an instrument panel of the host vehicle. The HUD is provided, for example, in the instrument panel in the vehicle compartment. The HUD projects a display image formed by a projector to a projection region specified in a front wind shield as a projection member. The light of the image reflected to the inside of the vehicle compartment by the front wind shield is perceived by the driver sitting on the driver's seat. In such a manner, the driver can visually recognize a virtual image of the display image formed in front of the front wind shield so as to be overlapped with a part of the front view. The HUD may have a configuration to project the display image to a combiner provided in front of the driver's seat in place of the front wind shield. The sound output device 172 makes a notification by outputting sound. An example of the sound output device 172 is a speaker or the like.

The user input device 18 receives an input from the user. The user input device 18 may be an operation device receiving an operation input from the user. The operation device may be a mechanical switch or a touch switch integrated with the display device 171. The user input device 18 is not limited to the operation device receiving an operation input as long as a device receives an input from the user. For example, a voice input device receiving an input of a command by voice of the user may be employed.

The HCU 19 is configured by using a computer, as a main body, having a processor, a volatile memory, a nonvolatile memory, an I/O, and a bus connecting those components. The HCU 19 executes various processes related to communication between an occupant and the system of the host vehicle by executing a control program stored in the nonvolatile memory. The HCU 19 obtains information of an input received from the user by the user input device 18. The HCU 19 makes the notifying device 17 perform a notification.

The autonomous driving ECU 10 is configured by using a computer, as a main body, having a processor, a volatile memory, a nonvolatile memory, an I/O, and a bus connecting those components. By executing a control program stored in the nonvolatile memory, the autonomous driving ECU 10 executes processes related to the autonomous driving. The autonomous driving ECU 10 corresponds to the vehicle control device. Hereinafter, it is assumed that the autonomous driving ECU 10 is used in a vehicle capable of executing at least autonomous driving without monitoring responsibility and autonomous driving with monitoring responsibility while switching them. The configuration of the autonomous driving ECU 10 will be specifically described hereinafter.

### (Schematic Configuration of Autonomous Driving ECU 10)

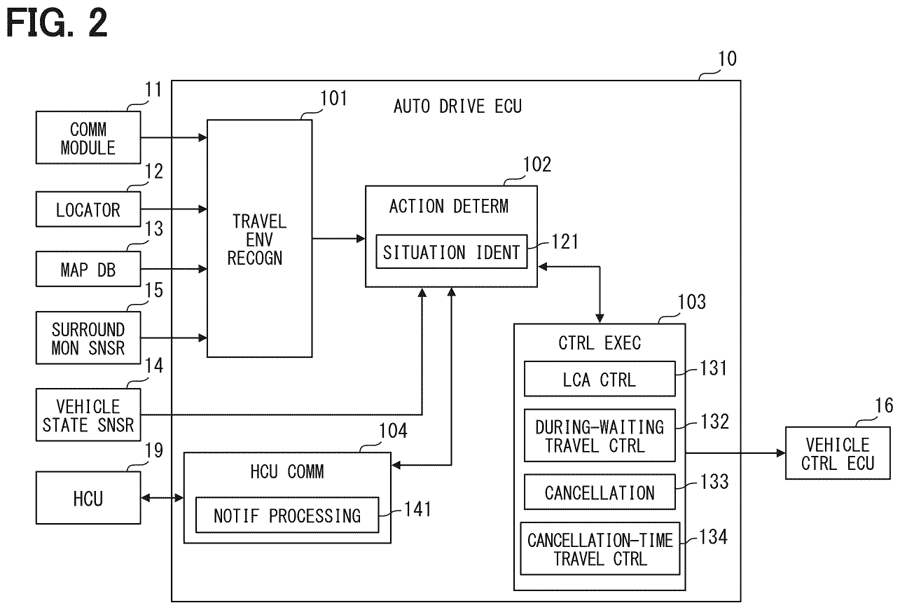

Subsequently, the schematic configuration of the autonomous driving ECU 10 will be described with reference to FIG. 2. As illustrated in FIG. 2, the autonomous driving ECU 10 has, as function blocks, a travel environment recognizing unit 101, an action determining unit 102, a control executing unit 103, and an HCU communication unit 104. Execution of processes of the function blocks of the autonomous driving ECU 10 by a computer corresponds to execution of a vehicle control method. A part of all of the functions executed by the autonomous driving ECU 10 may be configured in a hardware manner by one or a plurality of ICs or the like. A part or all of function blocks of the autonomous driving ECU 10 may be also realized by a combination of execution of software by a processor and a hardware member.

The travel environment recognizing unit 101 recognizes the travel environment of the host vehicle on the basis of the host vehicle position obtained from the locator 12, the map data obtained from the map DB 13, and the sensing information obtained from the surrounding monitoring sensor 15. As an example, the travel environment recognizing unit 101 recognizes the position, the shape, and a moving state of an object around the host vehicle by using the information and generates a virtual space reproducing actual travel environment. In the travel environment recognizing unit 101, it is sufficient to recognize the presence of a vehicle around the host vehicle, the position relative to the host vehicle, the speed relative to the host vehicle, and the like as travel environment on the basis of the sensing information obtained from the surrounding monitoring sensor 15. In the travel environment recognizing unit 101, it is sufficient to recognize the host vehicle position on a map on the basis of the host vehicle position and the map data. In the case where the position information, the speed information, and the like of a surrounding vehicle and the like can be obtained via the communication module 11, it is sufficient for the travel environment recognizing unit 101 to recognize the travel environment by using those information.

The travel environment recognizing unit 101 may also determine a manual driving area (hereinafter, MD area) in the travel region of the host vehicle. The travel environment recognizing unit 101 may also determine an autonomous driving area (hereinafter, AD area) in the travel region of the host vehicle. The travel environment recognizing unit 101 may also discriminate between an ST section and a non-ST section which will be described later in the AD area.

The MD area is an area in which autonomous driving is inhibited. In other words, the MD area is an area which is specified that the driver executes all of a vertical-direction control and a lateral-direction control of the host vehicle, and the surrounding monitoring. The vertical direction is a direction matching the front-back direction of the host vehicle. The lateral direction is a direction matching the width direction of the host vehicle. The vertical-direction control corresponds to acceleration/deceleration control of the host vehicle. The lateral-direction control corresponds to steering control of the host vehicle. For example, ordinary roads may be set as the MD area. The MD area may be a travel section in an ordinary road for which high-precision map data is not prepared.

The AD area is an area in which autonomous driving is allowed. In other words, the AD area is an area specified that the host vehicle can perform one or more of the vertical-direction control, the lateral-direction control, and the surrounding monitoring. For example, highways may be set as the AD area. The AD area may be a travel section for which high-precision map data is prepared. For example, autonomous driving in the area-limited LV3 (hereinafter, area-limited autonomous driving) is allowed only on highways. It is assumed that the autonomous driving in the traffic-congestion-limited LV3 (hereinafter, traffic-congestion-limited autonomous driving) is allowed only at the time of traffic congestion in the AD area. The travel environment recognizing unit 101 may determine the presence/absence of traffic congestion from traffic congestion information obtained from the center via the communication module 11. The travel environment recognizing unit 101 may determine the presence/absence of traffic congestion from the number of surrounding vehicles recognized, a distance between vehicles, speed, and the like.

The AD area is divided into an ST section and a non-ST section. The ST section is a section in which the area-limited autonomous driving is allowed. The non-ST section is a section in which autonomous driving and the traffic-congestion-limited autonomous driving of LV2 or lower can be performed. In the embodiment, the non-ST section in which the autonomous driving of LLLV1 is permitted and the non-SST section in which the autonomous driving of LV2 are not divided. The non-ST section is a section which does not correspond to the ST section in the AD area.

The action determining unit 102 switches the control primary body of the driving operation between the driver and the system of the host vehicle. When the system side has the driving operation control right, the action determining unit 102 determines a travel plan to make the host vehicle travel on the basis of a result of recognition of the travel environment by the travel environment recognizing unit 101. As travel plans, a medium- to long-term travel plan and a short-term travel plan are generated. In a medium- to long-term travel plan, a scheduled route for making the host vehicle travel toward a destination which is set is generated. The action determining unit 102 generates the scheduled route in a manner similar to a route search in the navigation function. For example, when the user input device 18 receives an input of the destination from the occupant, the action determining unit 102 may set the input destination as the destination of the scheduled route. The action determining unit 102 obtains the input of the destination received by the user input device 18 via the HCU 19 and the HCU communication unit 104. When an input of a destination is received from an occupant by a terminal on the outside of the host vehicle, the action determining unit 102 may set the input destination as the destination of the scheduled route. The action determining unit 102 obtains an input of a destination received by a terminal on the outside of the host vehicle via the communication module 11. When an input of a destination from the occupant is not received, the action determining unit 102 may estimate a tentative destination on the basis of a travel history or the like of the host vehicle and set the tentative destination as the destination. In this case, a destination of high travel frequency in the travel history based on the position of the host vehicle measured by the locator 12, the present time, the present day of the week, and the like may be estimated as a tentative destination.

In a short-term travel plan, the action determining unit 102 generates a scheduled travel path for realizing travel according to a medium- to long-term travel plan (that is, scheduled route) by using virtual space around the host vehicle created. Concretely, execution of steering for a lane change, acceleration/deceleration for speed adjustment, steering and braking for hindrance avoidance, and the like is determined.

The action determining unit 102 switches an automation level of the autonomous driving of the host vehicle as necessary. The action determining unit 102 determines whether the automation level can be raised or not. For example, in the case where the host vehicle moves from the MD area to the AD area, it may be determined that the driving below LV4 can be switched to the autonomous driving at LV4 or higher. In the case where it is determined that the automation level can be raised and the driver approves the raise in the automation level, the action determining unit 102 may increase the automation level.

When it is determined that the automation level has to be lowered, the action determining unit 102 lowers the automation level. As the case where it is determined that lowering of the automation level is necessary, time of override detection, time of calculated driving takeover, time of uncalculated driving takeover, and the like can be mentioned. Override is an operation for voluntarily obtaining the control right of the host vehicle by the driver of the host vehicle. In other words, the override is an operation intervention by the driver of the vehicle. The action determining unit 102 may detect override from the sensing information obtained from the vehicle state sensor 14. For example, when a steering torque detected by a steering torque sensor exceeds a threshold, the action determining unit 102 detects the override. In the case where press on the accelerator pedal is detected by the accelerator sensor, the action determining unit 102 detects the override. Moreover, when press on the brake pedal is detected by the brake sensor, the action determining unit 102 may detect the override. At the time of detection of the override, the action determining unit 102 lowers the automation level from the autonomous driving of LV1 or higher to the manual driving of LV0.

The calculated driving takeover is a scheduled driving takeover based on determination of the system. For example, a calculated driving takeover is performed when the host vehicle moves from the ST section to the non-ST section in the AD area. In this case, the action determining unit 102 switches the autonomous driving of the area-limited LV3 to the autonomous driving of LV2 or lower. That is, the autonomous driving without monitoring responsibility is switched to the autonomous driving with monitoring responsibility. The calculated driving takeover may be performed in the case where the host vehicle moves from the non-ST section in the AD area to the MD area. In this case, the automation level is switched from the autonomous driving of the area-limited LV3 to the manual driving of LV0. In the case where the start and end of a traffic congestion section can be predicted from traffic congestion information, calculated driving takeover may be performed at the time of movement from the traffic congestion section in the non-ST section to the outside of the traffic congestion section. In this case, for example, the autonomous driving of the traffic-congestion-limited LV3 is switched to the autonomous driving of LV2 or lower. The uncalculated driving takeover is unscheduled sudden driving takeover by determination of the system.

The action determining unit 102 performs the switching to lower the automation level, for example, in the case where the driver responds to a request from the system side of the vehicle. For example, in the case of switching the autonomous driving of the level 3 or higher to the autonomous driving of the level 2 or lower or the manual driving, the action determining unit 102 generates a driving takeover request and provides it to the HCU 19 via the HCU communication unit 104 which will be described later. When it is determined that the driver responds to the driving takeover request, the driving takeover is carried out.

The action determining unit 102 has a situation identifying unit 121 as a sub function block. The situation identifying unit 121 identifies circumstances of the host vehicle. The situation identifying unit 121 identifies the circumstances of the host vehicle from the travel environment of the host vehicle recognized by the travel environment recognizing unit 101, the above-described scheduled route, and the like. The process in the situation identifying unit 121 corresponds to a circumstance identifying step.

The situation identifying unit 121 identifies circumstance in which a lane change of the host vehicle is necessary (hereinafter, lane change necessary circumstance). An example of the lane change necessary circumstance is a circumstance in which the lane change from the lane of the host vehicle to another lane is necessary since the number of lanes in front of the lane in which the host vehicle travels decreases. Another example of the lane change necessary circumstance is a circumstance in which the lane change from the lane of the host vehicle to another lane is necessary due to right/left turn along a scheduled route or approach to a fork road.

When the lane change necessary circumstance is identified, the situation identifying unit 121 identifies whether the circumstance allows the lane change or not. As an example, in the case where a surrounding vehicle does not exist in a predetermined range (hereinafter, a target range) on the sides and the rear side of the host vehicle before start of the lane change, in a destination lane due to the lane change (hereinafter, LC destination lane), a circumstance in which the lane change is possible may be identified. In the case where a surrounding vehicle exists in the target range in the LC destination lane, a circumstance in which the lane change is not possible may be identified. The target range can be arbitrarily set.

In the case where the situation identifying unit 121 identifies the lane change necessary circumstance and identifies the circumstance in which the lane change is possible, the action determining unit 102 determines execution of an automatic lane change. In the case where the action determining unit 102 determines execution of the automatic lane change, an LCA control unit 131 in the control executing unit 103 starts the automatic lane change.

When the system side of the host vehicle has the control right of the driving operation, the control executing unit 103 executes a travel control such as acceleration/deceleration control, steering control, and the like of the host vehicle in accordance with a travel plan determined by the action determining unit 102 in cooperation with the vehicle control ECU 16. The control executing unit 103 has the LCA control unit 131, a during-waiting travel control unit 132, a cancellation unit 133, and a cancellation-time travel control unit 134 as sub function blocks.

The LCA control unit 131 makes the lane change performed automatically. The LCA control unit 131 performs LCA control to automatically change the host vehicle from the travel lane of the host vehicle (hereinafter, the host vehicle lane) to an adjacent lane. In the LCA control, based on a result of recognition of the travel environment by the travel environment recognizing unit 101 or the like, a scheduled travel path in a shape smoothly connecting the target position in the host vehicle lane to the center of the adjacent lane is generated. By automatically controlling the steering angle of the steering wheel of the host vehicle in accordance with the scheduled travel path, the lane change from the host vehicle lane to the adjacent lane is performed. For example, it is assumed that the automatic lane change is performed after the travel position in the host vehicle lane is moved toward the end part on the side to which the lane of the host vehicle in the host vehicle lane is changed (hereinafter, the LC-side end part). The processes in the during-waiting travel control unit 132, the cancellation unit 133, and the cancellation-time travel control unit 134 will be described later.

In the case where a situation that the lane change is not possible is identified after start of the automatic lane change and before completion of the lane change, the situation identifying unit 121 identifies a waiting situation in which the lane change is interrupted in the middle and waiting is necessary. Hereinafter, the waiting situation identified by the situation identifying unit 121 during the autonomous driving without monitoring responsibility of the host vehicle will be called a first waiting situation. Hereinafter, the waiting situation identified by the situation identifying unit 121 during the autonomous driving with monitoring responsibility of the host vehicle will be called a second waiting situation. The situation identifying unit 121 may discern start of the automatic lane change by, for example, monitoring the control executing unit 103.

In the case of identifying the waiting situation, the situation identifying unit 121 also identifies the cause of interruption of the lane change. The situation identifying unit 121 identifies the cause of the interruption of the lane change (hereinafter, interruption cause), for example, on the basis of the travel environment recognized by the travel environment recognizing unit 101. As an example, in the case where a surrounding vehicle entering the target range from the rear lateral side of the host vehicle exists, the rear lateral vehicle is identified as the interruption cause. As another example, in the case where a surrounding vehicle entering the target range from the front lateral side of the host vehicle exists, traffic congestion or the front lateral vehicle is identified as the interruption cause.

In the case where the waiting situation is identified by the situation identifying unit 121, the action determining unit 102 determines to set a waiting state in which the automatic lane change is interrupted in the middle and waited. When the action determining unit 102 determines to set the waiting state, the situation identifying unit 121 may identify a progress situation of the lane change of the host vehicle. As the progress situation of the lane change, whether the compartment line on the lane change side (hereinafter, LC-side compartment line) in the compartment lines of the host vehicle lane is crossed over or not may be identified. The compartment line of the vehicle lane can be also called a lane border line.

The during-waiting travel control unit 132 in the control executing unit 103 executes travel control in the waiting state in the automatic lane change. The during-waiting travel control unit 132 may be included in the LCA control unit 131. When the first waiting situation is identified by the situation identifying unit 121, the during-waiting travel control unit 132 makes the host vehicle travel in the waiting state. An example of the travel of the host vehicle in the waiting state will be described later. Preferably, the during-waiting travel control unit 132 makes the host vehicle travel while moving the travel position of the host vehicle in the host vehicle lane toward the LC end part side on the basis of the first waiting situation identified by the situation identifying unit 121. Since there is the possibility that the driver is executing a second task during the autonomous driving without monitoring responsibility, it is preferable to make a change in the behavior of the host vehicle smaller so as not to disturb the second task. With the above-described configuration, during the autonomous driving without monitoring responsibility, even in the case where the automatic lane change is in the waiting state, travel in the state where the host vehicle is moved to the LC end part side for the lane change can be continued. Therefore, a change in the behavior of the host vehicle can be made smaller, and the second task of the driver is not disturbed.

In the case where the first waiting situation is identified by the situation identifying unit 121 and the host vehicle crosses over the LC-side compartment line, more preferably, the during-waiting travel control unit 132 moves the travel position of the host vehicle back to the inside of the host vehicle lane and then makes the vehicle travel in the LC side end part. On the other hand, in the case where the first waiting situation is identified by the situation identifying unit 121 and the host vehicle does not cross over the LC-side compartment line, it is more preferable to move the travel position of the host vehicle back to the center of the host vehicle lane and make the host vehicle travel. The reason is that when the host vehicle does not cross over the LC-side compartment line, even when the travel position of the host vehicle is moved back to the center of the host vehicle lane, a change in the behavior of the host vehicle does not become large.

In the case where the second waiting situation is identified by the situation identifying unit 121, preferably, the during-waiting travel control unit 132 moves the travel position of the host vehicle back to the center of the host vehicle lane and makes the host vehicle travel regardless of whether the host vehicle crosses over the LC-side compartment line or not. The reason is that, since a second task is not performed during autonomous driving with monitoring responsibility, even when the travel position of the host vehicle is moved back to the center of the vehicle lane, a second task is not disturbed.

Preferably, in the waiting situation of the host vehicle, the situation identifying unit 121 identifies also a takeover situation in the waiting state in which driving takeover is necessary from autonomous driving without monitoring responsibility to driving with surrounding monitoring responsibility. Examples that driving takeover becomes necessary from the autonomous driving without monitoring responsibility to driving with surrounding monitoring responsibility include transition from the ST section to the non-ST section and ending of traffic congestion in the non-ST section. The takeover situation in the waiting state may include driving takeover from autonomous driving without monitoring responsibility to manual driving.

In the case where the takeover situation in the waiting state is identified by the situation identifying unit 121, the action determining unit 102 determines to cancel the automatic lane change. The cancellation unit 133 of the control executing unit 103 executes travel control to cancel the automatic lane change. In the case where the situation identifying unit 121 identifies the takeover situation in the waiting state, the cancellation unit 133 cancels the automatic lane change. When the cancellation unit 133 cancels the automatic lane change, the cancellation-time travel control unit 134 moves the travel position of the host vehicle to the center of the host vehicle lane and makes the vehicle travel. Also in the case where lapse time since the host vehicle enters the waiting state becomes designated time and a timeout occurs, the cancellation unit 133 cancels the automatic lane change.

In the case where the situation identifying unit 121 identifies a situation that the lane change is possible during the waiting state of the host vehicle, the action determining unit 102 may determine a re-challenge to restart the automatic lane change. When the action determining unit 102 determines a re-challenge, the LCA control unit 131 restarts the automatic lane change. When the waiting state of the host vehicle continues for designated time or longer, the during-waiting travel control unit 132 may execute a timeout to finish the waiting situation. The designated time may be time which can be arbitrarily set. When the waiting state is finished, for example, the program shifts to LTA control which will be described later.

In the embodiment, although description is omitted for convenience, the control executing unit 103 may perform not only the LCA control but also other travel controls such as ACC (Adaptive Cruise Control) and LTA (Lane Tracing Assist) control. The ACC is a control realizing constant-speed travel of the host vehicle at set vehicle speed or travel tracing a preceding vehicle. The LTA control is a control of maintaining travel within a lane of the host vehicle. In the LTA control, a steering control is performed so as to maintain the travel within the lane of the host vehicle. As an example, in the LTA control, it is sufficient to perform the steering control so that the travel position of the host vehicle is maintained in the center of the host vehicle lane. In the case of starting a lane change in the LCA control, the LTA control is temporarily interrupted so that departing from the host vehicle lane becomes possible. After completion of the lane change, the LTA control is restarted.

The HCU communication unit 104 performs a process of outputting information toward the HCU 19 and a process of obtaining information from the HCU 19. The HCU communication unit 104 obtains input information and the like received by the user input device 18. The HCU communication unit 104 has a notification processing unit 141 as a sub function block. The notification processing unit 141 indirectly controls notification in the notifying device 17 by sending an instruction to the HCU 19. The notification processing unit 141 corresponds to a notification control unit. The process in the notification processing unit 141 corresponds to a notification controlling step.

In the case where the first waiting situation is identified by the situation identifying unit 121, the notification processing unit 141 makes a notification to notify of a waiting state in which the automatic lane change cannot be completed (hereinafter, waiting notification) and a notification to notify of a cause of the waiting state (hereinafter, waiting cause notification). The waiting notification and the waiting cause notification may be made from a display device 171 or a sound output device 172. For example, the waiting notification and the waiting cause notification may be made by display in the display device 171. An example of display of the waiting notification and the waiting cause notification is as follows.

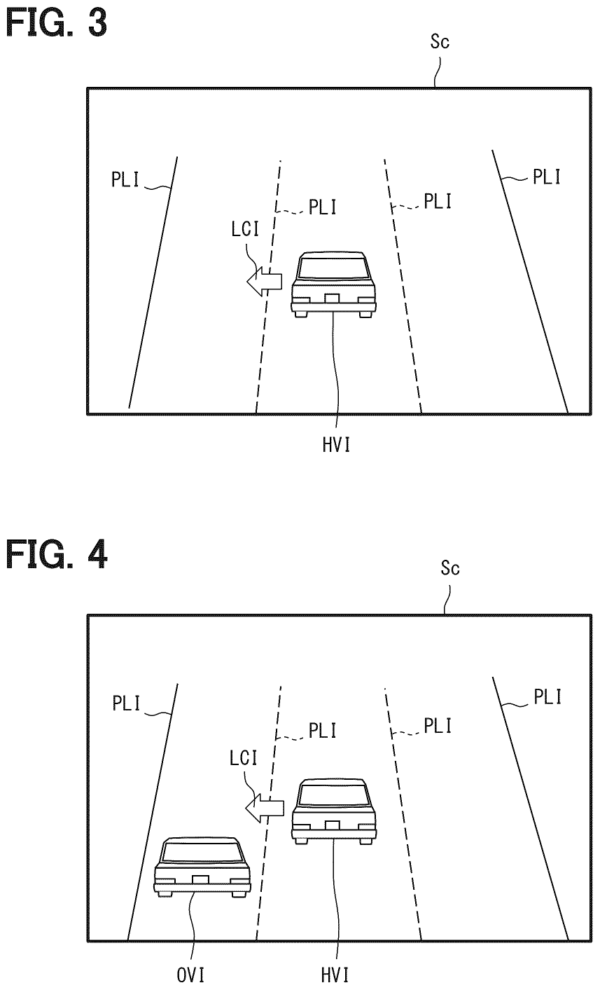

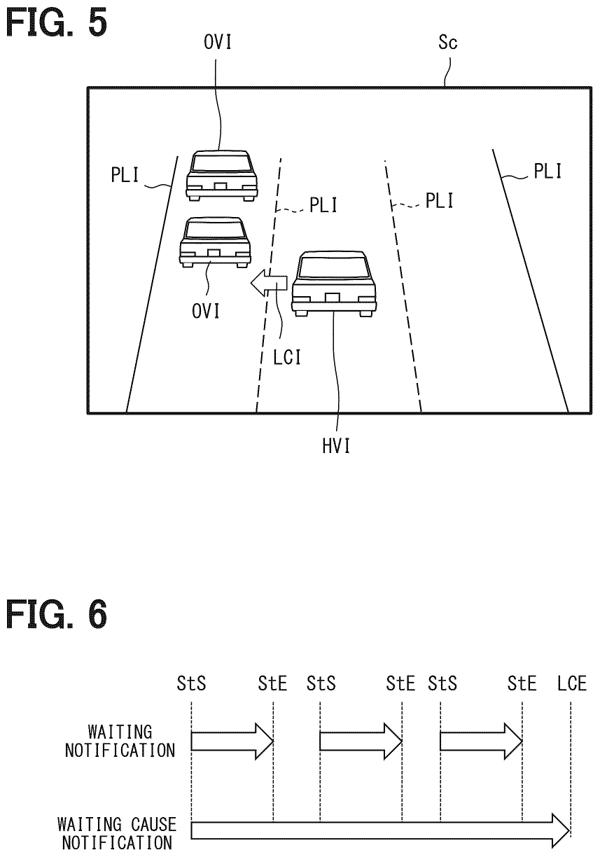

With reference to FIGS. 3 to 5, an example of the waiting notification and the waiting cause notification will be described. FIG. 3 is a display example of an image for illustrating a surrounding situation of a host vehicle (hereinafter, surrounding situation image) when the host vehicle is not in the waiting state. FIGS. 4 and 5 are display examples of a surrounding situation image when the host vehicle is in the waiting state. The surrounding situation image is displayed, for example, in the meter MID. The surrounding situation image may be an overview image of the host vehicle and its surrounding, seen from a virtual viewpoint above the host vehicle. The virtual viewpoint may be a point above the host vehicle or a position deviated from the point above the host vehicle. For example, a plane view from a virtual viewpoint above and rearward of the host vehicle may be used. The surrounding situation image may be a virtual image for illustrating the surrounding situation of the host vehicle or may be obtained by processing images captured by a surrounding monitoring camera in the surrounding monitoring sensor 15.

Sc in FIGS. 3 to 5 indicates a display screen of the display device 171. PLI in FIGS. 3 to 5 indicates an image expressing a compartment line of a lane (hereinafter, compartment line image). HVI in FIGS. 3 to 5 indicates an image expressing the host vehicle (hereinafter, host vehicle image). OVI in FIGS. 3 to 5 indicates an image expressing a vehicle around the host vehicle (hereinafter, surrounding vehicle image). LCI in FIGS. 3 to 5 indicates an image expressing an automatic lane change of the host vehicle (hereinafter, LC image). In FIGS. 3 to 5, the icon of the arrow indicating the direction of the automatic lane change of the host vehicle is illustrated as an example of the LC image. In the surrounding situation image, an image expressing the vehicle speed of the host vehicle and the like may be also displayed.

As illustrated in FIG. 3, the state of the host vehicle which is not in the waiting state may be expressed by displaying no surrounding vehicle image at a destination of the lane change illustrated by the LC image. As illustrated in FIG. 4, the state of the host vehicle which is in the waiting state may be expressed by displaying the surrounding vehicle image at a destination of the lane change illustrated by the LC image. Display of the surrounding vehicle image at the destination of the lane change indicated by the LC image corresponds to a waiting notification. The waiting notification may be made by other expressions such as superimposition of a mark expressing interruption on the LC image or display of text expressing the waiting state. It is sufficient to express the waiting cause notification by a mode of placement of the surrounding vehicle image for the host vehicle image. For example, as illustrated in FIG. 4, by displaying the surrounding vehicle image positioned diagonally backward of the host vehicle image at the destination of the lane change indicated by the LC image, it may be expressed that the cause of the waiting state is the diagonally backward vehicle. On the other hand, as illustrated in FIG. 5, by displaying a plurality of surrounding vehicle images positioned diagonally forward of the host vehicle image at the destination of the lane change indicated by the LC image, it may be expressed that the cause of the waiting state is traffic congestion. The waiting cause notification may be made by displaying an icon or text expressing the cause of the waiting state.

With the above configuration, in the case where a waiting state occurs after start of the automatic lane change during autonomous driving without monitoring responsibility, a waiting notification and a waiting cause notification are made. Therefore, even when the driver does not grasp the situation around the host vehicle during autonomous driving without monitoring responsibility, the driver can grasp the waiting state more easily. As a result, it is possible to reduce a feeling of strangeness given to the driver even when a lane change has to be waited during an automatic lane change in autonomous driving without monitoring responsibility.

On the other hand, when the situation identifying unit 121 identifies the second waiting situation, preferably, the notification processing unit 141 makes the waiting notification but does not make the waiting cause notification. The reason is that since the driver is supposed to grasp the situation around the host vehicle during autonomous driving with surrounding monitoring responsibility, the necessity to notify even the cause of the waiting state is low.

When the takeover situation during waiting is identified by the situation identifying unit 121, preferably, the notification processing unit 141 makes a notification to notify cancellation of the automatic lane change (hereinafter, cancellation notification) and a notification to notify driving takeover (hereinafter, driving takeover notification) subsequent to the cancellation notification. When the notification processing unit 141 makes the cancellation notification, cancellation of the automatic lane change in the cancellation unit 133 is also performed. As an example of the cancellation notification, it is sufficient to make the LC image disappear in the surrounding situation image. Alternatively, display of an icon expressing cancellation, display of a text, or output of sound may be performed. As an example of the driving takeover notification, an icon expressing driving takeover may be displayed in the surrounding situation image. Alternatively, display of a text expressing driving takeover or sound output may be performed.

With the above configuration, when driving takeover from the autonomous driving without monitoring responsibility to driving with surrounding monitoring responsibility becomes necessary when the host vehicle is in the waiting state, the cancellation notification and the driving takeover notification subsequent to the cancellation notification are made. Therefore, even in the case where the driver does not grasp the situation around the host vehicle during autonomous driving without monitoring responsibility, the driver can more easily grasp the situation that the automatic lane change is cancelled and the driving takeover becomes necessary.

In the case where the situation identifying unit 121 identifies the first waiting situation, preferably, the notification processing unit 141 sends a notification to prompt the driver to monitor surroundings (hereinafter, monitoring prompting notification) even during the automatic driving without monitoring responsibility. An example of the monitoring prompting notification is display of an icon prompting surrounding monitoring. Alternatively, display of a text or sound output prompting surrounding monitoring may be performed. In such a manner, even in the case where the driver does not grasp the situation around the host vehicle, by prompting grasp of the situation around the host vehicle, anxiety can be lessened. Also in the case where the second waiting situation is identified by the situation identifying unit 121, the notification processing unit 141 may perform the monitoring prompting notification.

At the time of re-challenge to perform the automatic lane change again after the host vehicle enters the waiting state, preferably, the notification processing unit 141 also makes the display device 171 perform display related to a lane change (hereinafter, LC-related display), which is not made perform the LC-related display before the re-challenge. The expression “after the host vehicle enters the waiting state” can be also made as “after the automatic lane change cannot be completed”. As an example, the LC-related display is performed only in the meter MID before a re-challenge. On the other hand, the LC-related display is performed in the meter MID and the CID at the time of a re-challenge. In other words, before a re-challenge, the display device 171 provided for a second task is not allowed to perform the LC-related display. On the other hand, at the time of a re-challenge, the display device 171 provided for a second task is also made perform the LC-related display. With the above configuration, by adding the display device 171 for the display at the time of a re-challenge, awareness can be increased by the display related to the lane change. The above-described process may be limited to the case where the host vehicle enters the waiting state during autonomous driving without monitoring responsibility. In such a manner, even the driver who does not grasp the situation around the host vehicle is easily aware of the situation by the display related to the lane change. The display related to a lane change may be the above-described display of an LC image. Alternatively, the display related to a lane change may be a waiting notification or a waiting cause notification by display.

Preferably, the notification processing unit 141 does not finish the waiting cause notification even when the cause of the waiting state is solved and continues it until the continuation time of the waiting cause notification reaches predetermined time or the automatic lane change is completed. The predetermined time may be time which can be arbitrarily set. In such a manner, even in the case where the first waiting situation occurs continuously, the waiting cause notification is continuously performed. Therefore, even in the case where the first waiting situation occurs continuously, troublesomeness that the waiting cause notification frequently starts and ends can be suppressed.

Referring now to FIG. 6, the end timing of the waiting cause notification will be described. FIG. 6 illustrates an example of the case where completion of an automatic lane change is the end timing of a waiting cause notification. StS in FIG. 6 indicates occurrence of the first waiting situation, and StE indicates the end of the first waiting situation. LCE denotes completion of an automatic lane change. Arrows in FIG. 6 indicate notification periods of a waiting notification and a waiting cause notification. As illustrated in FIG. 6, with respect to a waiting notification, the notification starts at the occurrence of the first waiting situation and ends at the end of the first waiting situation. On the other hand, the waiting cause notification is continued regardless of the end of the occurrence of the first waiting situation, and finished at the time of completion of an automatic lane change. In the case where the cause of the first waiting situation is traffic congestion, the waiting cause notification may be started/finished at the end of the occurrence of the first waiting situation. The reason is that, since the possibility that the first waiting situation whose cause is traffic congestion frequently occurs/ends is lower, even the notification is started/ended at the occurrence/end of the first waiting situation, the waiting cause notification is not so troublesome.

Preferably, the notification processing unit 141 makes the notifying device 17 notify of start of a lane change at the time of start of the automatic lane change of the host vehicle. As an example, the display device 171 displays the above-described LC image. In the case where the waiting state occurs in the configuration that a notification of start of a lane change is made at the time of start of a lane change during autonomous driving without monitoring responsibility, a sense of discomfort tends to be particularly given to the driver. During the autonomous driving without monitoring responsibility in which the possibility that the driver does not grasp the situation around the host vehicle is high, when the waiting state occurs regardless of a notification of starting a lane change, it becomes more difficult for the driver to grasp of the situation. To deal with it, by making the notification processing unit 141 make a waiting notification and a waiting cause notification, even in the situation where a sense of discomfort tends to be particularly given to the driver, the sense of discomfort given to the driver can be suppressed.

### (LC Waiting Related Process in Autonomous Driving ECU 10)

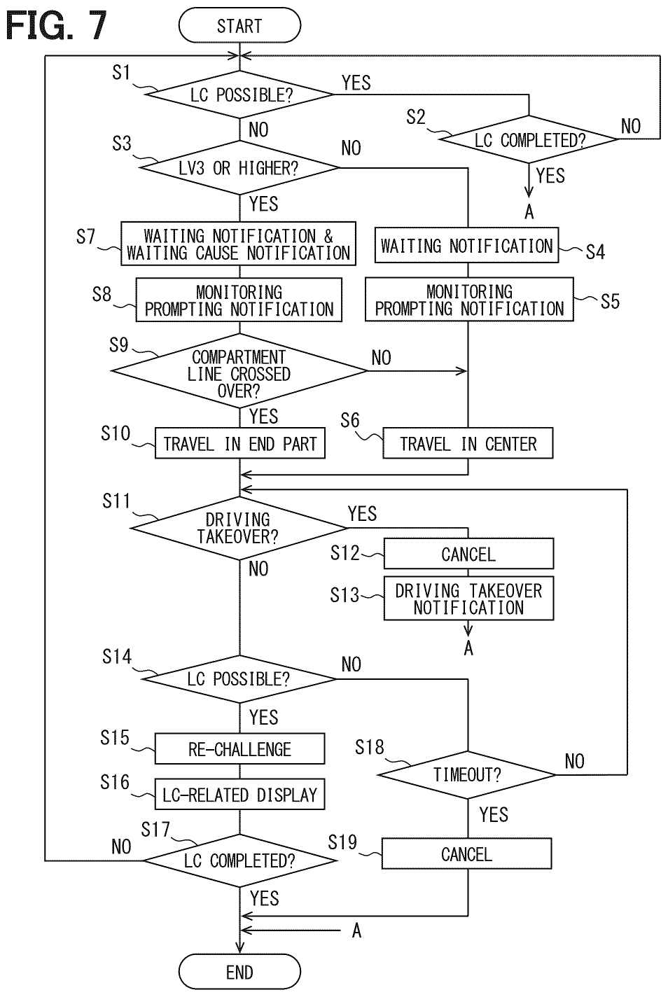

With reference to the flowchart of FIG. 7, an example of the flow of processes related to waiting for an automatic lane change (hereinafter, LC waiting related processes) in the autonomous driving ECU 10 will be described. The flowchart of FIG. 7 may be started when the host vehicle starts an automatic lane change. That is, at the time of start of the flowchart of FIG. 7, the host vehicle is in the autonomous driving.

First, in step S1, the situation identifying unit 121 identifies whether a situation allows a lane change (hereinafter, LC) or not. In the case of a situation that allows the LC (YES in S1), the program moves to step S2. On the other hand, in the case of a situation that does not allow the LC (NO in S1), the program moves to step S3.

In step S2, in the case where the host vehicle completes the LC (YES in S2), the LC waiting related process is finished. On the other hand, in the case where the host vehicle has not completed the LC (NO in S2), the program returns to S1 and repeats the process. Whether the host vehicle completes the LC or not may be identified by the situation identifying unit 121.

In step S3, when the automation level of the host vehicle is LV3 or higher (YES in S3), the program moves to step S7. That is, in the case where the host vehicle is in the autonomous driving without monitoring responsibility, the program moves to step S7. The situation of the host vehicle in the case of moving to S7 is the first waiting situation. On the other hand, in the case where the automation level of the host vehicle is less than L3 (NO in S3), the program moves to step S4. That is, when the host vehicle is in the autonomous driving with monitoring responsibility, the program moves to step S4. The situation of the host vehicle in the case of moving to S4 is the second waiting situation. The automation level of the host vehicle may be determined by the action determining unit 102.

In step S4, by an instruction of the notification processing unit 141, a waiting notification is made from the notifying device 17. In step S5, by an instruction of the notification processing unit 141, a monitoring prompting notification is made from the notifying device 17. In step S6, the during-waiting travel control unit 132 moves the travel position of the host vehicle to the center of the host vehicle lane and makes the host vehicle travel. The program moves to step S11.

On the other hand, in step S7, by an instruction of the notification processing unit 141, a waiting notification and a waiting cause notification are made from the notifying device 17. In step S8, by an instruction of the notification processing unit 141, a monitoring prompting notification is made from the notifying device 17. In the case where the situation identifying unit 121 identifies that the host vehicle crosses over the LC-side compartment line in step S9 (YES in S9), the program moves to step S10. On the other hand, when the situation identifying unit 121 identifies that the host vehicle does not cross over the LC-side compartment line (NO in S9), the program moves to S6. In step S10, the during-waiting travel control unit 132 moves the travel position of the host vehicle back to the indie of the host vehicle lane and then makes the host vehicle travel in the end part on the LC side. The program moves to step S11.

In the case where the situation identifying unit 121 identifies a takeover situation during waiting in step S11 (YES in S11), the program moves to step S12. On the other hand, in the case where the situation identifying unit 121 does not identify a takeover situation during waiting (NO in S11), the program moves to step S14. The move to step S12 is not limited to the driving takeover from the autonomous driving without monitoring responsibility to the autonomous driving with monitoring responsibility but may be also made by the driving takeover from the autonomous driving with the monitoring responsibility to manual driving in step S11.

In step S12, the cancellation unit 133 cancels the LC. In S12, by an instruction of the notification processing unit 141, a cancellation notification is made from the notifying device 17. In step S13, by an instruction of the notification processing unit 141, the driving takeover notification is made from the notifying device 17. After that, the LC waiting related process is finished. In the case of the driving takeover from the autonomous driving with monitoring responsibility to the manual driving, processes similar to S12 and S13 may be performed or different process may be performed. For example, the number of kinds of notifications may be changed by omitting the cancellation notification.

In step S14, the situation identifying unit 121 identifies whether a situation allows the LC or not. In the case of the situation where the LC is possible (YES in S14), the program moves to step S15. On the other hand, in the case of the situation where the LC is not possible (NO in S14), the program moves to step S17.

In step S15, the LCA control unit 131 restarts the LC. That is, a re-challenge is performed. In step S16, by an instruction of the notification processing unit 141, the display device 171 which does not perform the LC-related display before a re-challenge is also made perform the LCA-related display. When the host vehicle completes the LC in step S17 (YES in S17), the LC waiting related process is finished. On the other hand, when the host vehicle has not completed the LC (NO in S17), the program returns to S1 and repeats the process.

In the case where the lapse time since the host vehicle enters the waiting state reaches designated time and a timeout occurs in step S18 (YES in S18), the program moves to step S19. On the other hand, in the case where a timeout does not occur (NO in S18), the program returns to S11 and repeats the process. For example, the cancellation unit 133 determines the lapse time since the host vehicle enters the waiting state by using a timer circuit or the like. In step S19, the cancellation unit 133 cancels the LC and finishes the LC waiting related process. In S19, by an instruction of the notification processing unit 141, a cancellation notification may be made from the notifying device 17.

### Second Embodiment

The present disclosure is not limited to the configuration of the first embodiment, but the following configuration of a second embodiment may be employed. Hereinafter, an example of the configuration of the second embodiment will be described with reference to the drawings. The system 1 for a vehicle of the second embodiment is similar to the system 1 for a vehicle of the first embodiment except for the point that an autonomous driving ECU 10a is included in place of the autonomous driving ECU 10.

### (Schematic Configuration of Autonomous Driving ECU 10a)

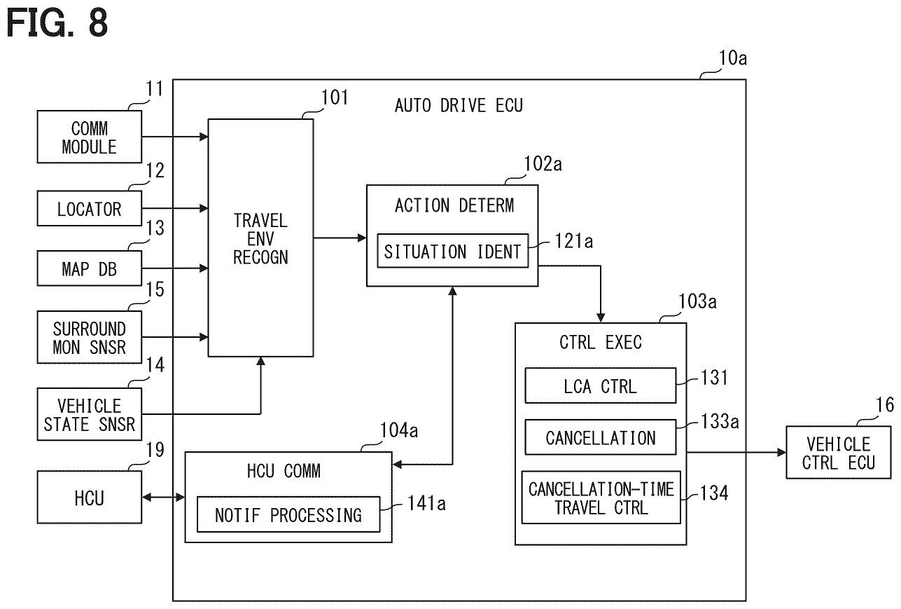

The autonomous driving ECU 10a has, as illustrated in FIG. 8, the travel environment recognizing unit 101, an action determining unit 102a, a control executing unit 103a, and an HCU communication unit 104a as function blocks. The autonomous driving ECU 10a is similar to the autonomous driving ECU 10 of the first embodiment except for the point that the action determining unit 102a, the control executing unit 103a, and the HCU communication unit 104a are provided in place of the action determining unit 102, the control executing unit 103, and the HCU communication unit 104. The autonomous driving ECU 10a also corresponds to a vehicle control device. Execution of processes of the function blocks of the autonomous driving ECU 10a by a computer corresponds to execution of a vehicle control method.

The action determining unit 102a has a situation identifying unit 121a as a sub function block. The situation identifying unit 121a is similar to the situation identifying unit 121 of the first embodiment except for the point that a takeover situation during waiting is not identified. The process in the situation identifying unit 121a also corresponds to a situation identifying step. The action determining unit 102a is similar to the action determining unit 102 of the first embodiment except for the point that, in the case where a waiting state is identified, determination is not made so as to set a waiting state by interrupting the automatic lane change in the middle and making the host vehicle waiting but determination is made to cancel the automatic lane change. In the second embodiment, a state where the automatic lane change is cancelled and cannot be executed is also regarded as a waiting state.

The control executing unit 103a has the LCA control unit 131, a cancellation unit 133a, and the cancellation-time travel control unit 134 as sub function blocks. The control executing unit 103a is similar to the control executing unit 103 of the first embodiment except for the point that the during-waiting travel control unit 132 is not provided and the point that the cancellation unit 133a is provided in place of the cancellation unit 133.

The cancellation unit 133a cancels the automatic lane change when lapse time since the host vehicle enters the waiting state reaches designated time and a timeout occurs. In the second embodiment, since the takeover situation in the waiting state is not identified by the situation identifying unit 121a, different from the first embodiment, a process on the condition that the takeover situation in the waiting state is identified is not performed.

The HCU communication unit 104a has a notification processing unit 141a as a sub function block. The HCU communication unit 104a is similar to the HCU communication unit 104 of the first embodiment except for the point that the notification processing unit 141a is provided in place of the notification processing unit 141. In the case where the first waiting situation is identified by the situation identifying unit 121a, the notification processing unit 141a moves the travel position of the host vehicle back to the center of the host vehicle lane by the cancellation-time travel control unit 134 and, after that, makes a waiting notification and a waiting cause notification. The waiting notification and the waiting cause notification may be made in a manner similar to those described in the first embodiment. The notification processing unit 141a also corresponds to a notification control unit. The process in the notification processing unit 141a also corresponds to a notification control step. In the second embodiment, the cancellation notification in the first embodiment may be used as a waiting notification. In the case where the cancellation notification in the first embodiment is not used as the waiting notification, a cancellation notification may be made in addition to a waiting notification similar to that in the first embodiment.

With the above configuration, in a manner similar to the first embodiment, in the case where a waiting state occurs due to cancellation of an automatic lane change after start of the automatic lane change in the autonomous driving without monitoring responsibility, a waiting notification and a waiting cause notification are made. Therefore, even in the case where the lane change has to be waited during the automatic lane change in the autonomous driving without monitoring responsibility, a sense of discomfort given to the driver can be suppressed.

In a manner similar to the notification processing unit 141, in the case where the second waiting situation is identified by the situation identifying unit 121a, the notification processing unit 141a makes the waiting notification. However, it is preferable not to make the waiting cause notification. At the time of a re-challenge of performing the automatic lane change again after the automatic lane change of the host vehicle is cancelled, preferably, the notification processing unit 141a also makes the display device 171 which is not made the LC-related display before the re-challenge perform the LC-related display. The expression “after the automatic lane change of the host vehicle is cancelled” can be also changed as “after the automatic lane change cannot be completed”.

In a manner similar to the notification processing unit 141, preferably, the notification processing unit 141a does not finish the waiting cause notification even when the cause of the waiting state is solved but continues it until continuation time of the waiting cause notification reaches predetermined time or the automatic lane change is completed.

### (LC Waiting Related Process in Autonomous Driving ECU 10a)

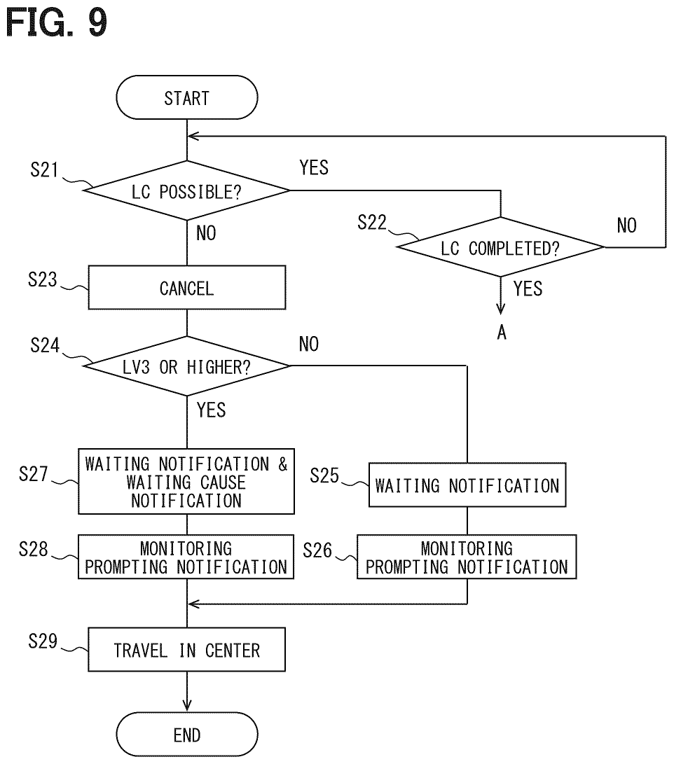

Referring now to the flowchart of FIG. 9, an example of the flow of the LC waiting related process in the autonomous driving ECU 10a will be described. The flowchart of FIG. 9 also may be started in the case where the host vehicle starts the automatic lane change.

First, in step S21, the situation identifying unit 121a identifies whether or not situation allows a lane change (hereinafter, LC). In the case of the situation where the LC is possible (YES in S21), the program moves to step S22. On the other hand, in the case of the situation where the LC is not possible (NO in S21), the program moves to step S23.

In step S22, when the host vehicle completes the LC (YES in S22), the LC waiting related process is finished. On the other hand, when the host vehicle has not completed the LC (NO in S22), the program returns to S21 and repeats the process. Whether the host vehicle completed the LC or not may be identified by the situation identifying unit 121a. In step S23, the cancellation unit 133a cancels the LC.

In the case where the automation level of the host vehicle is LV3 or higher in step S24 (YES in S24), the program moves to step S27. The situation of the host vehicle in the case of moving to S27 is the first waiting situation. On the other hand, in the case where the automation level of the host vehicle is lower than LV3 (NO in S24), the program moves to step S25. The situation of the host vehicle in the case of moving to S25 is the second waiting situation. The automation level of the host vehicle may be determined by the action determining unit 102a.

In step S25, by an instruction of the notification processing unit 141a, a waiting notification is made from the notifying device 17. As the waiting notification, the cancellation notification in the first embodiment may be used. In the case where the cancellation notification in the first embodiment is not used as a waiting notification, the cancellation notification in the first embodiment may be made in S23. In step S26, by an instruction of the notification processing unit 141a, a monitoring prompting notification is made from the notifying device 17. After that, the program moves to step S29.

On the other hand, in step S27, by an instruction of the notification processing unit 141a, a waiting notification and a waiting cause notification are made from the notifying device 17. The waiting notification is similar to the waiting notification in S25. In step S28, by an instruction of the notification processing unit 141a, a monitoring prompting notification is made from the notifying device 17. In step S29, the cancellation-time travel control unit 134 moves the travel position of the host vehicle back to the center of the host vehicle lane and makes the host vehicle travel, and the LC waiting related process is finished.

### Third Embodiment

The present disclosure is not limited to the configurations of the foregoing embodiments but may employ the following configuration of a third embodiment. Hereinafter, an example of the third embodiment will be described with reference to the drawings.

### (Schematic Configuration of System 1b for Vehicle)

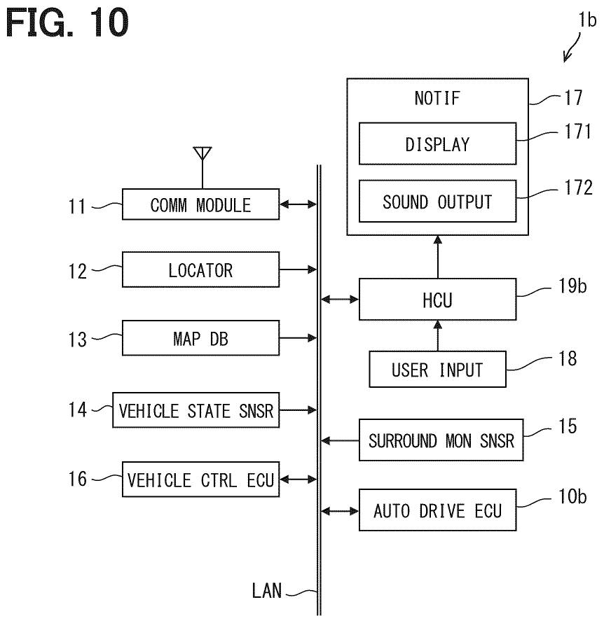

A system 1b for a vehicle illustrated in FIG. 10 can be used in an autonomous driving vehicle. As illustrated in FIG. 10, the system 1b for a vehicle includes an autonomous driving ECU 10b, the communication module 11, the locator 12, the map DB 13, the vehicle state sensor 14, the surrounding monitoring sensor 15, the vehicle control ECU 16, the notifying device 17, the user input device 18, and an HCU 19b. The system 1b for a vehicle includes the autonomous driving ECU 10b in place of the autonomous driving ECU 10. The system 1b for a vehicle includes the HCU 19b in place of the HCU 19. The system 1b for a vehicle is similar to the system 1 for a vehicle of the first embodiment except for those points.

The HCU 19b is similar to the HCU 19 of the first embodiment except for the point that a part of the process is different. The different point will be described. The HCU 19b performs display related to a second task in a display region in the display device 171. The display related to a second task is display provided for the driver in a second task. An example is display of content of video or the like.

### (Schematic Configuration of Autonomous Driving ECU 10b)

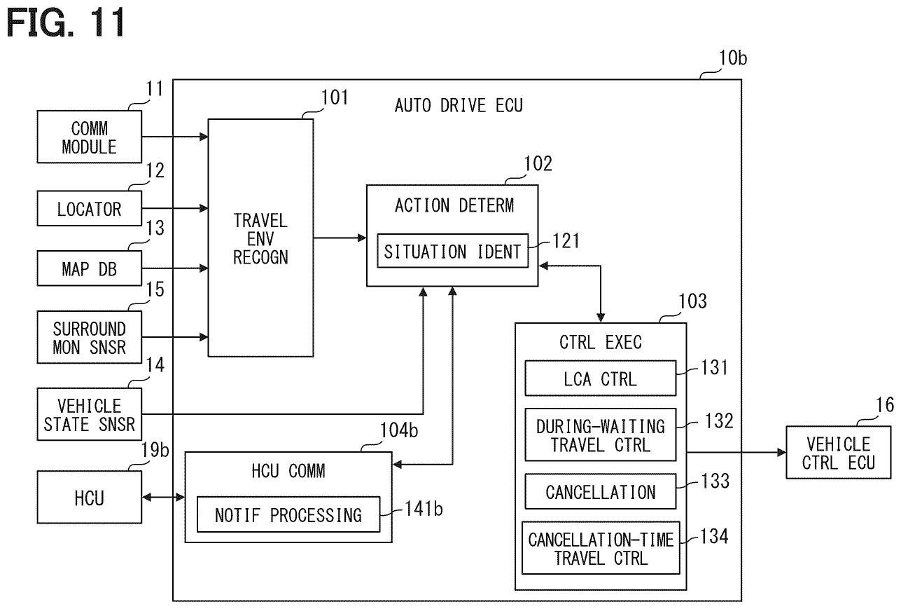

As illustrated in FIG. 11, the autonomous driving ECU 10b has the travel environment recognizing unit 101, the action determining unit 102, the control executing unit 103, and an HCU communication unit 104b as function blocks. The autonomous driving ECU 10b is similar to the autonomous driving ECU 10 of the first embodiment except for the point that the HCU communication unit 104b is provided in place of the HCU communication unit 104. The autonomous driving ECU 10b also corresponds to a vehicle control device. Execution of processes of the function blocks of the autonomous driving ECU 10b by a computer corresponds to execution of a vehicle control method.

The HCU communication unit 104b has a notification processing unit 141b as a sub function block. The notification processing unit 141b also corresponds to a notification control unit. The HCU communication unit 104b is similar to the HCU communication unit 104 of the first embodiment except for the point that the notification processing unit 141b is provided in place of the notification processing unit 141. The notification processing unit 141b is similar to the notification processing unit 141 of the first embodiment except for the point that a part of the process is different. Hereinafter, the different point will be described.

In the case where the first waiting situation is identified by the situation identifying unit 121, the notification processing unit 141b performs waiting state display in the display region of the display device 171 performing display related to a second task. The waiting state display is a notification indicating that the host vehicle is in the waiting state. The waiting state display may be a text or an icon. In such a manner, the driver who is concentrated in a second task can be also easily made recognize that the host vehicle is in the waiting state. Preferably, the waiting state display is made in the display region in the display device 171 together with the display related to the second task. The purpose is to notify the driver of the waiting state of the host vehicle while trying not to disturb the second task. The waiting state display may be made in the display region in the display device 171 in place of the display related to the second task.

When the waiting state of the host vehicle times out, preferably, the notification processing unit 141b finishes the waiting state display before the timeout. “Before the timeout” may be “just before the timeout”. “Just before the timeout” is, for example, time of less than a few seconds as the remaining time of the timeout. Consequently, even in the case where a change occurs in the behavior of the host vehicle by a timeout of the waiting state, the driver prepares for the change more easily. Preferably, the notification processing unit 141b makes a notification indicating that the waiting state times out at a timing deviated from the timing of finishing the waiting state display. Hereinafter, the notification indicating that the waiting state times out will be called a timeout notification. In such a manner, as compared with the case where the end of the waiting state display and the timeout notification are performed at the same time, confusion and misperception of the driver can be suppressed. The notification processing unit 141b may make the timeout notification by either display or sound output.

### (Timeout-Related Notification Process in Autonomous Driving ECU 10b)

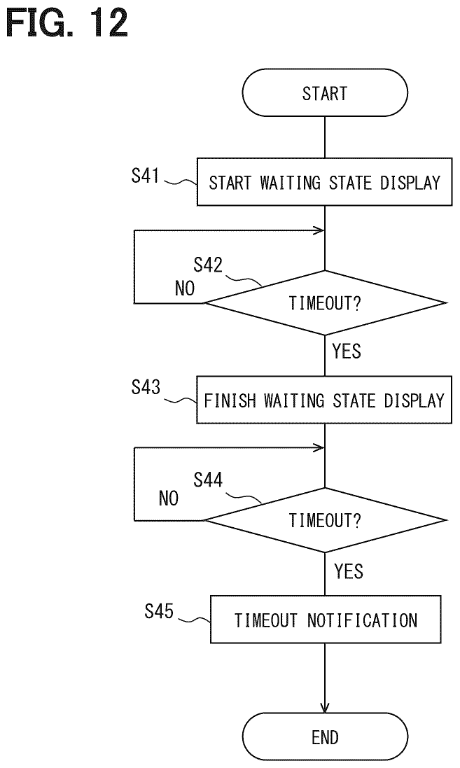

An example of the flow of process of a notification related to a timeout of a waiting state in the autonomous driving ECU 10b will be described with reference to the flowchart of FIG. 12. The process will be called a timeout related notification process. The flowchart of FIG. 12 may be started in the case where the first waiting situation is identified by the situation identifying unit 121. As the start condition of the flowchart of FIG. 12, a condition that display related to a second task is performed in the display region of the display device 171 may be added.

First, in step S41, the notification processing unit 141b performs waiting state display in the display region of the display device 171 performing display related to a second task. In the case where the during-waiting travel control unit 132 determines that the waiting state times out in step S42 (YES in S42), the program moves to step S43. The during-waiting travel control unit 132 may determine a timeout of the waiting state when the remaining time of the continuation time of the waiting state to the designated time becomes little. As an example, determination may be made when the remaining time of the continuation time of the waiting state to the designated time becomes one second. On the other hand, when the during-waiting travel control unit 132 does not determine that the waiting state times out (NO in S42), the process of S42 is repeated.

In step S43, the notification processing unit 141b finishes the waiting state display. When the during-waiting travel control unit 132 determines that the waiting state times out in step S44 (YES in S44), the program moves to step S45. On the other hand, in the case where the during-waiting travel control unit 132 does not determine that the waiting state times out (NO in S44), the process of S44 is repeated. In step S45, the notification processing unit 141b makes the notifying device 17 make the timeout notification and finishes the timeout related notifying process.

### Fourth Embodiment

The present disclosure is not limited to the configurations of the foregoing embodiments but may employ the following configuration of a fourth embodiment. Hereinafter, an example of the configuration of the fourth embodiment will be described with reference to the drawings.

### (Schematic Configuration of System 1c for Vehicle)

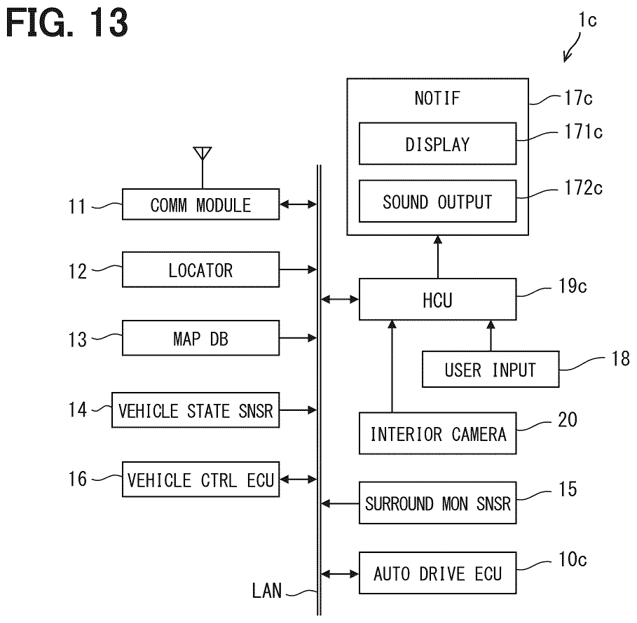

A system 1c for a vehicle illustrated in FIG. 13 can be used for an autonomous driving vehicle. As illustrated in FIG. 13, the system 1c for a vehicle includes an autonomous driving ECU 10c, the communication module 11, the locator 12, the map DB 13, the vehicle state sensor 14, the surrounding monitoring sensor 15, the vehicle control ECU 16, a notifying device 17c, the user input device 18, an HCU 19c, and an interior camera 20. The system 1c for a vehicle includes the autonomous driving ECU 10c in place of the autonomous driving ECU 10. The system 1c for a vehicle includes the notifying device 17c in place of the notifying device 17. The system 1c for a vehicle includes the HCU 19c in place of the HCU 19. The system 1c for a vehicle includes the interior camera 20. The system 1c for a vehicle is similar to the system 1 for a vehicle of the first embodiment except for those points.

The notifying device 17c is similar to the notifying device 17 of the first embodiment except for the point that the operation of a direction indicator is notified. The direction indicator can be also called a turn signal lamp, a turn lamp, or a blinker lamp. The notifying device 17c has a display device 171c and a sound output device 172c. The display device 171c is similar to the display device 171 of the first embodiment except for the point of displaying the operation of the direction indicator. The display related to the operation of the direction indicator may be display indicating the direction of the direction indicator which is operating. This display may be display by the indicator. This display may be display of an icon in the meter MID. The display related to the operation of the direction indicator will be called direction indicating operation display hereinafter. The sound output device 172c is similar to the sound output device 172 of the first embodiment except for the point that sound related to the operation of the direction indicator is output. The sound may be electronic synthetic sound or the like which is output according to the blinking of the direction indicator. Hereinafter, the output of the sound related to the operation of the direction indicator will be called a direction indication operation sound output. Notification on the operation of the direction indicator includes the direction indication operation display and the direction indication operation sound output.

The interior camera 20 shoots a predetermined range in the compartment of the host vehicle. The interior camera 20 shoots a range including at least the driver's seat of the host vehicle. The interior camera 20 may shoot a range including not only the driver's seat but also the front passenger seat and backseats of the host vehicle. The interior camera 20 is configured by, for example, a near-infrared light source, a near-infrared camera, a control unit controlling those components, and the like. The interior camera 20 shoots an occupant in the host vehicle irradiated with near-infrared light from the near-infrared light source by the near-infrared camera. An image captured by the near-infrared camera is subjected to image analysis by the control unit. The control unit analyzes the captured image and detects feature amounts of the face of the occupant. The control unit may detect the direction of the face of the occupant, the direction of the gaze of the occupant, the line of sight, and the like on the basis of feature amounts of the upper part of the body including the face of the occupant detected.

The HCU 19c is similar to the HCU 19 of the first embodiment except for the point that a part of process is different. The different point will be described. Hereinafter, the different point will be described. The HCU 19c controls notification related to the operation of the direction indicator in the notifying device 17c. Preferably, the HCU 19c estimates whether the driver is executing a second task or not. The HCU 19c may estimate whether the driver is executing a second task or not on the basis of the direction of the face of the driver, the line of sight, posture, and the like detected by the interior camera 20. The HCU 19c may estimate whether the driver is executing a second task or not from an input received by the user input device 18. For example, since an input is received by a touch switch integrated with the CID, it may be estimated that the driver is executing a second task. Hereinafter, a result of estimation in the HCU 19c of whether the driver is executing a second task will be called a state estimation result.

### (Schematic Configuration of Autonomous Driving ECU 10c)

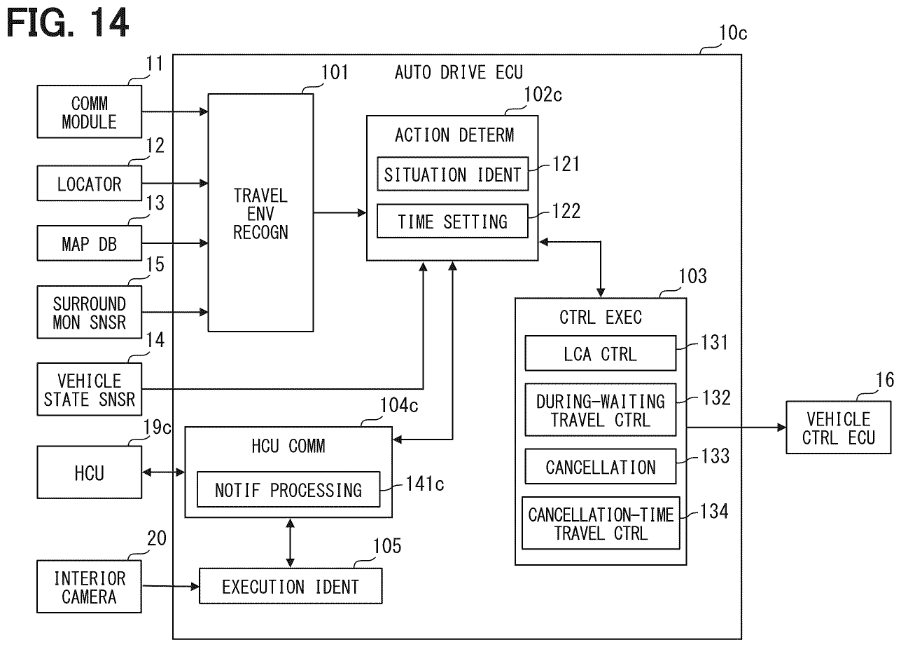

As illustrated in FIG. 14, the autonomous driving ECU 10c has the travel environment recognizing unit 101, the action determining unit 102c, the control executing unit 103, an HCU communication unit 104c, and an execution identifying unit 105 as function blocks. The autonomous driving ECU 10c has the action determining unit 102c in place of the action determining unit 102. The autonomous driving ECU 10c has the HCU communication unit 104c in place of the HCU communication unit 104. The autonomous driving ECU 10c has the execution identifying unit 105. The autonomous driving ECU 10c is similar to the autonomous driving ECU 10 of the first embodiment except for those points. The autonomous driving ECU 10c also corresponds to a vehicle control device. Execution of processes of the function blocks of the autonomous driving ECU 10c by a computer corresponds to execution of a vehicle control method.

The execution identifying unit 105 identifies whether the driver is executing a second task or not. The execution identifying unit 105 may identify whether the driver is executing a second task or not by obtaining a state estimation result from the HCU 19c. It is sufficient for the execution identifying unit 105 to obtain the state estimation result from the HCU 19c via the HCU communication unit 104.

The action determining unit 102c has the situation identifying unit 121 and a time setting unit 122 as sub function blocks. The action determining unit 102c is similar to the action determining unit 102 of the first embodiment except for the point that the time setting unit 122 is provided. The time setting unit 122 changes the designated time of a timeout of the waiting state. In the case where the execution identifying unit 105 identifies that the driver is executing a second task, the time setting unit 122 changes the designated time of a timeout to be longer. Regarding the change to be longer, it is sufficient to change the designated time to be longer than that in the case where it is identified that the driver is not executing a second task.

When the driver is executing a second task, the awareness to the behavior of the host vehicle is low. Therefore, even when the waiting state continues long, the possibility that the driver is not aware of the continuation is high. With the above configuration, the waiting state can be made longer while suppressing the sense of discomfort given to the driver.

The HCU communication unit 104c has a notification processing unit 141c as a sub function block. The notification processing unit 141c also corresponds to a notification control unit. The HCU communication unit 104c is similar to the HCU communication unit 104 of the first embodiment except for the point that the notification processing unit 141c is provided in place of the notification processing unit 141. The notification processing unit 141c is similar to the notification processing unit 141 of the first embodiment except for the point that a part of the process is different. Hereinafter, the different point will be described.

The notification processing unit 141c also controls a notification regarding the operation of the direction indicator of the host vehicle toward the inside of the compartment of the host vehicle. The notification processing unit 141c indirectly controls a notification regarding the operation of the direction indicator by sending an instruction to the HCU 19c. In the case where the execution identifying unit 105 identifies that the driver is executing a second task, the notification processing unit 141c suppresses the notification regarding the operation of the direction indicator of the host vehicle in the notifying device 17. In such a manner, the second task can be less disturbed by the notification regarding the operation of the direction indicator. As an example of the suppression, although the direction indication operation display is performed, the direction indication operation sound is not output. Consequently, while suppressing the sound which tends to disturb a second task, the operation of the direction indicator can be notified by display. Alternatively, the suppression may be carried out by reducing the intensity of both of the direction indication operation display and the direction instruction operation sound output.

### (Second Task Related Process in Autonomous Driving ECU 10c)

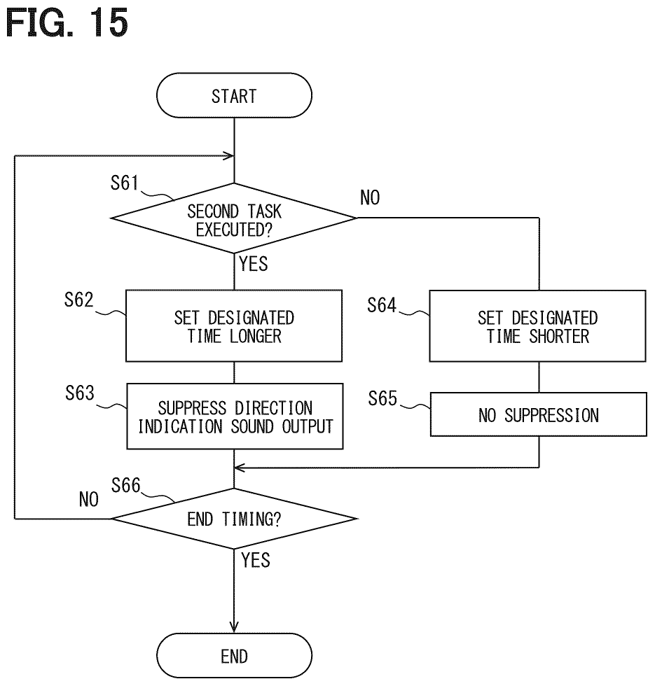

An example of the flow of process according to the presence/absence of a second task (hereinafter, a second task related process) in the autonomous driving ECU 10c will be described with reference to the flowchart of FIG. 15. This process will be called a second task related process. The flowchart of FIG. 15 may be started when the host vehicle starts the autonomous driving at LV3 or higher. That is, it starts when the host vehicle starts the autonomous driving without monitoring responsibility.

First, when the execution identifying unit 105 identifies that the driver is executing a second task in step S61 (YES in S61), the program moves to step S62. On the other hand, when the execution identifying unit 105 identifies that the driver is not executing a second task (NO in S61), the program moves to step S64.

In step S62, the time setting unit 122 sets the designated time of a timeout to be longer than that in the case where it is identified that the driver is not executing a second task. In step S63, the notification processing unit 141c allows the direction indication operation display but suppresses the direction indication operation sound output. The program moves to step S66.

In step S64, the time setting unit 122 sets the designated time of a timeout to be shorter than that in the case where it is identified that the driver is executing a second task. In step S65, the notification processing unit 141c does not suppress both the direction indication operation display and the direction indication operation sound output. After that, the program moves to step S66. In the case of the second task related process ending timing in step S66 (YES in S66), the second task related process is finished. On the other hand, in the case where it is not the second task related process ending timing, the program returns to S61 and repeats the process. An example of the ending timing is the timing when the host vehicle finishes the autonomous driving without monitoring responsibility.

### Fifth Embodiment

The present disclosure is not limited to the configurations of the foregoing embodiments but may employ the following configuration of a fifth embodiment. Hereinafter, an example of the configuration of the fifth embodiment will be described with reference to the drawings.

### (Schematic Configuration of System 1d for Vehicle)

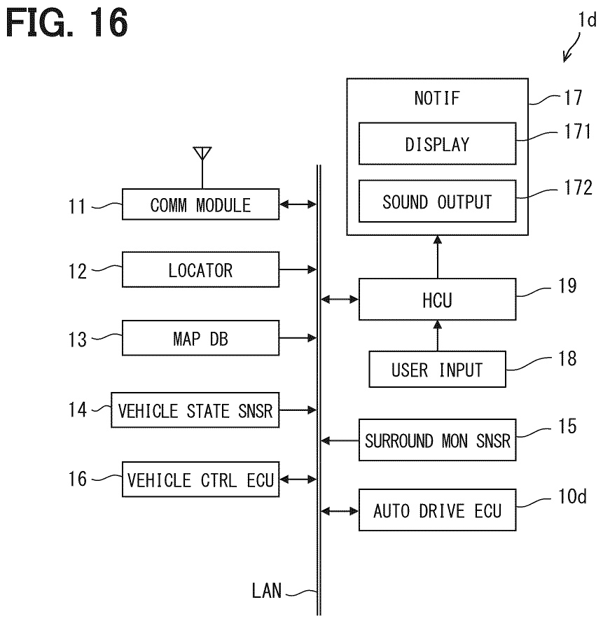

A system 1d for a vehicle illustrated in FIG. 16 can be used for an autonomous driving vehicle. As illustrated in FIG. 16, the system 1d for a vehicle includes an autonomous driving ECU 10d, the communication module 11, the locator 12, the map DB 13, the vehicle state sensor 14, the surrounding monitoring sensor 15, the vehicle control ECU 16, the notifying device 17, the user input device 18, and the HCU 19. The system 1d for a vehicle is similar to the system 1 for a vehicle of the first embodiment except for the point that the autonomous driving ECU 10d is included in place of the autonomous driving ECU 10.

### (Schematic Configuration of Autonomous Driving ECU 10d)

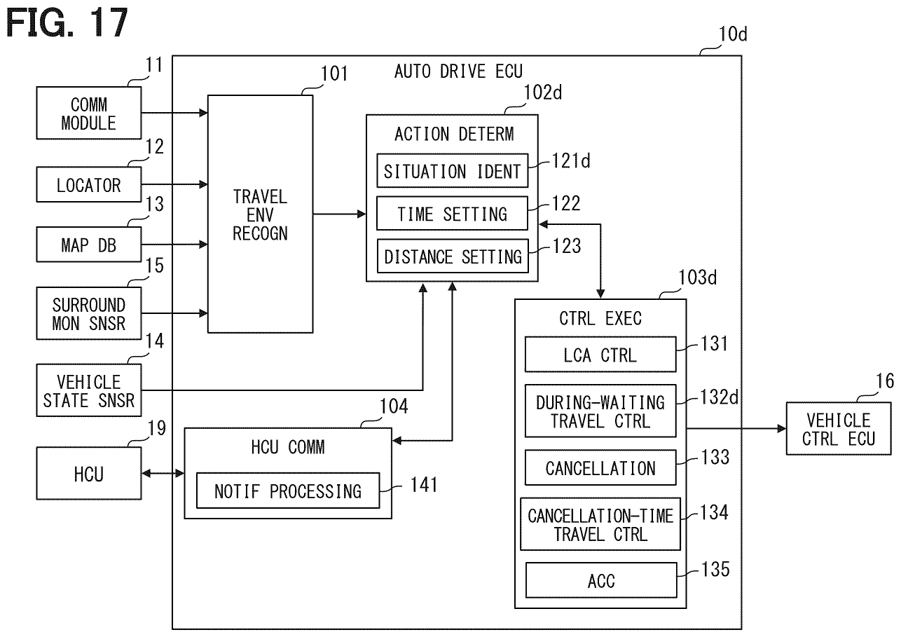

As illustrated in FIG. 17, the autonomous driving ECU 10d has the travel environment recognizing unit 101, an action determining unit 102d, a control executing unit 103d, and the HCU communication unit 104 as function blocks. The autonomous driving ECU 10d has the action determining unit 102d in place of the action determining unit 102. The autonomous driving ECU 10d has the control executing unit 103d in place of the control executing unit 103. The autonomous driving ECU 10d is similar to the autonomous driving ECU 10 of the first embodiment except for those points. The autonomous driving ECU 10d also corresponds to a vehicle control device. Execution of processes of the function blocks of the autonomous driving ECU 10d by a computer corresponds to execution of a vehicle control method.

The action determining unit 102d has a situation identifying unit 121d, a time setting unit 122d, and a distance setting unit 123 as sub function blocks. The situation identifying unit 121d is similar to the situation identifying unit 121 of the first embodiment except for the point that a part of the process is different. Hereinafter, the different point will be described. The situation identifying unit 121d identifies whether traffic is being congested or not. That is, the situation identifying unit 121d identifies whether or not traffic is being congested in the situation of the host vehicle. It is sufficient for the situation identifying unit 121d to identify whether traffic in the section in which the host vehicle travels is being congested or not. The situation identifying unit 121d may identify whether traffic in the section in which the host vehicle travels is being congested or not from traffic congestion information around the host vehicle received from the center by the communication module 11. Alternatively, the situation identifying unit 121d may identify whether traffic in the section in which the host vehicle travels is being congested or not from a combination of information of the position and speed of another vehicle and the information of the speed of the host vehicle. It is sufficient to identify the information of the position and speed of another vehicle on the basis of sensing information obtained from the surrounding monitoring sensor 15. It is sufficient to obtain information of the speed of the host vehicle from a vehicle speed sensor in the vehicle state sensor 14. For example, when the number of other vehicles around the host vehicle is large and the speeds of the host vehicle and preceding and following vehicles of the host vehicle are low, it may be identified that traffic in the section in which the host vehicle travels is being congested. The situation identifying unit 121d may identify whether traffic in the section in which the host vehicle travels is being congested or not by means other than the above-described ways.

Preferably, the situation identifying unit 121d identifies whether traffic in the host vehicle lane and an adjacent lane is being congested or not. It is sufficient to identify whether or not the traffic in the host vehicle lane is being congested or not from a combination of information of the position and speed of another vehicle and information of the speed of the host vehicle. For example, when the speeds of the preceding and following vehicles of the host vehicle are low, it may be identified that the traffic in the host vehicle lane is being congested. Whether the traffic in the adjacent lane of the host vehicle is being congested or not may be also identified by a combination of information of the positions and speeds of other vehicles and information of the speed of the host vehicle. For example, when the number of other vehicles in the adjacent lane is large and the speeds of the other vehicles are low, it may be identified that the traffic in the adjacent lane of the host vehicle is being congested. The situation identifying unit 121d may identify whether or not the traffic in the host vehicle lane and the adjacent lane is being congested by means other than the above-described means. Hereinafter, the situation where the traffic in the host vehicle lane and the adjacent lane is being congested will be called a both-lane congested situation. Hereinafter, a situation that the traffic in the host vehicle lane is being congested but the traffic in the adjacent lane is not being congested will be called an only-host-vehicle-lane congested situation.

Preferably, the situation identifying unit 121d identifies whether the surrounding monitoring sensor 15 of the host vehicle detects preceding and following vehicles in the host vehicle lane. The situation identifying unit 121d may identify whether the preceding and following vehicles in the host vehicle lane are detected or not from the travel environment of the host vehicle recognized by the travel environment recognizing unit 101. The details of the time setting unit 122d and the distance setting unit 123 will be described later.

The control executing unit 103d has the LCA control unit 131, a during-waiting travel control unit 132d, the cancellation unit 133, the cancellation-time travel control unit 134, and an ACC unit 135 as sub function blocks. The control executing unit 103d has the during-waiting travel control unit 132d in place of the during-waiting travel control unit 132. The control executing unit 103d has the ACC unit 135 as an essential component. The control executing unit 103d is similar to the control executing unit 103 of the first embodiment.

The ACC unit 135 performs the ACC described in the first embodiment.

The during-waiting travel control unit 132d is similar to the during-waiting travel control unit 132 in the first embodiment except for the point that a part of the process is different. Hereinafter, the different point will be described. When the situation identifying unit 121d identifies the traffic congestion state, the during-waiting travel control unit 132d makes the host vehicle travel as follows as travel in the waiting state. The during-waiting travel control unit 132d makes the host vehicle travel so that the travel position of the host vehicle is moved to an end part on the side to which the lane was being changed in the host vehicle lane more than the case where the traffic congestion state is not identified. It is considered that, at the time of traffic congestion, when the host vehicle is moved to the end part on the side to which the lane was being changed, the chance that the rearward vehicle in the lane change destination makes space for the lane change increases. Therefore, with the above configuration, even at the time of traffic congestion, a lane change becomes easier.

The time setting unit 122d is similar to the time setting unit 122 of the fourth embodiment except for the point that a part of the process is different. Hereinafter, the different point will be described. When the situation identifying unit 121d identifies a traffic congestion state, preferably, the time setting unit 122d sets the designated time to be longer than that in the case where the traffic congestion state is not identified. Since the speed of a vehicle in traffic congestion is low, even when the host vehicle travels in the end part of the host vehicle lane in the waiting state, adjacency to a surrounding vehicle is easily avoided. Therefore, when adjacency to surrounding vehicles is easily avoided even in the waiting state, by continuing the waiting state long, a lane change can be facilitated.

When the situation that the surrounding monitoring sensor 15 of the host vehicle detects the preceding and following vehicles in the host vehicle lane is identified by the situation identifying unit 121d, preferably, the time setting unit 122d changes the designated time of a timeout to be longer. Regarding the change to be longer, it is sufficient to change the situation that at least one of the preceding and following vehicles in the host vehicle lane cannot be detected by the surrounding monitoring sensor 15 to be longer than that in the case identified by the situation identifying unit 121d. In the case where the surrounding monitoring sensor 15 can detect preceding and following vehicles, the host vehicle can be avoided from becoming very close to the preceding and following vehicles more easily as compared with the case where at least any of the preceding and following vehicles cannot be detected. Therefore, in the case where the preceding and following vehicles are easily avoided from coming very close even in the waiting state, the waiting state is continued long so that a lane change can be easily performed.

The distance setting unit 123 changes a target distance between vehicles in cruise travel control in which the distance between the host vehicle and a preceding vehicle of the host vehicle is maintained at the target distance. That is, the distance setting unit 123 changes the target distance between vehicles in the above-described ACC. Preferably, the distance setting unit 123 changes the target distance between vehicles between the case where the both-lane congested situation is identified by the situation identifying unit 121d and the case where the only-host-vehicle-lane congested situation is identified by the situation identifying unit 121d. In such a manner, when an allowable or preferable target distance between vehicles varies between the both-lane congested situation and the only-host-vehicle-lane congested situation, the target distance between vehicles can be changed according to the situation.

When the only-host-vehicle-lane congested situation is identified by the situation identifying unit 121d, preferably, the distance setting unit 123 makes the target distance between vehicles longer than that in the case where the both-lane congested situation is identified by the situation identifying unit 121d. Consequently, the host vehicle can be easily accelerated and, even in the case where the traffic in the host vehicle lane is congested, the lane change to the adjacent lane is easily made. In the case where the only-host-vehicle-lane congested situation is identified by the situation identifying unit 121d, the target distance between vehicles may be set longer than that in the case where the both-lane congested situation is identified by the situation identifying unit 121d. Consequently, by making the target distance between vehicles longer, changes of vehicles between the host vehicle lane and the adjacent lane are prompted, so that the lane change of the host vehicle can be facilitated.

### (Setting Change Related Process in Autonomous Driving ECU 10d)

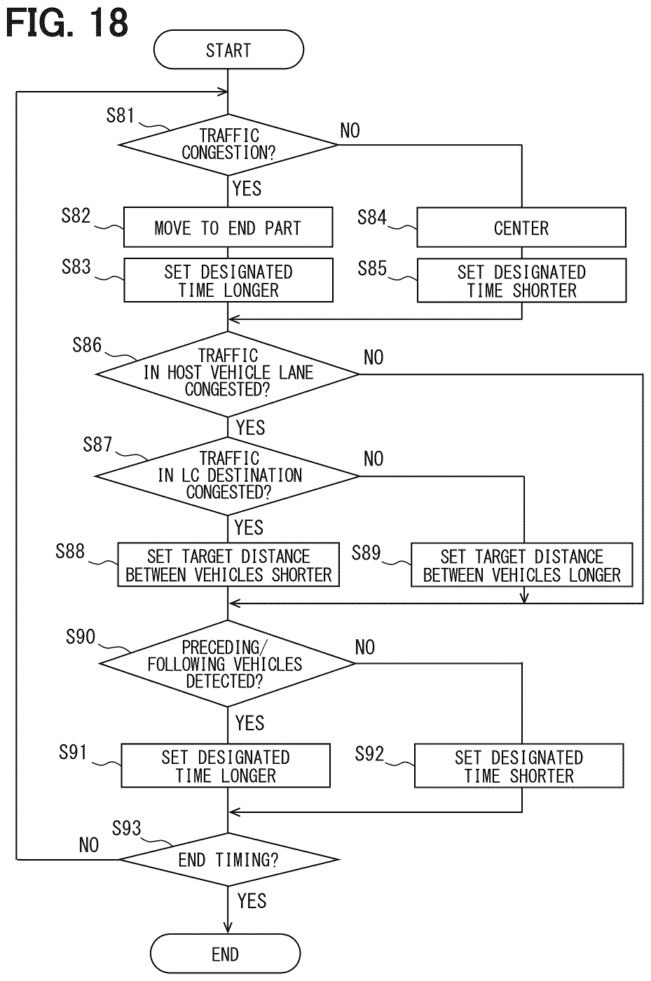

By referring now to the flowchart of FIG. 18, an example of the flow of process related to a setting change in the waiting state in the autonomous driving ECU 10d will be described. This process will be called a setting change related process. The flowchart of FIG. 18 may be started in the case where the first waiting situation is identified by the situation identifying unit 121.

First, when the situation identifying unit 121d identifies that traffic is being congested in step S81 (YES in S81), the program moves to step S82. On the other hand, when the situation identifying unit 121d identifies that traffic is not congested (NO in S81), the program moves to step S84.

In step S82, the during-waiting travel control unit 132 makes the host vehicle travel while moving the travel position of the host vehicle to an end part on the side of the lane to which the vehicle was tried to change. In step S83, the time setting unit 122d sets the designated time of a timeout to be longer than that in the case where it is not identified that traffic is congested. After that, the program moves to step S86.

In step S84, the during-waiting travel control unit 132d makes the host vehicle travel so that the travel position of the host vehicle is in the center of the host vehicle lane. In step S85, the time setting unit 122d sets the designated time of a timeout to be shorter than that in the case where it is not identified that traffic is congested. After that, the program moves to step S86.

When the situation identifying unit 121d identifies that the traffic in the host vehicle lane is contested in step S86 (YES in S86), the program moves to step S87. On the other hand, when the situation identifying unit 121d identifies that the traffic in the host vehicle lane is not congested (NO in S86), the program moves to step S90. When it is identified that the traffic in the adjacent lane as the destination of the lane change is congested in step S87 (YES in S87), the program moves to step S88. In FIG. 18, the adjacent lane as the destination of the lane change is expressed as LC destination. On the other hand, when it is identified that the traffic in the adjacent lane as the destination of the lane change is not congested (NO in S87), the program advances to step S89.

In step S88, the distance setting unit 123 sets the target distance between vehicles to be shorter than that in the case where the only-host-vehicle-lane congested situation is identified by the situation identifying unit 121d. After that, the program moves to step S90. In step S89, the distance setting unit 123 sets the target distance between vehicles to be longer than that in the case where the both-lane congested situation is identified by the situation identifying unit 121d.

When the situation identifying unit 121d identifies a situation that the preceding and following vehicles can be detected by the surrounding monitoring sensor 15 in step S90 (YES in S90), the program moves to step S91. On the other hand, when the situation identifying unit 121d identifies a situation that at least any of the preceding and following vehicles cannot be detected by the surrounding monitoring sensor 15 (NO in S90), the program moves to step S92.

In step S91, the time setting unit 122d sets the designated time of a timeout to be longer than that in the case where at least any of the preceding and following vehicles cannot be detected. After that, the program moves to step S93. In step S92, the time setting unit 122d sets the designated time of a timeout to be shorter than that in the case where the preceding and following vehicles can be detected. After that, the program moves to step S93.

When it is the ending timing of the setting change related process in step S93 (YES in S93), the setting change related process is finished. On the other hand, when it is not the end timing of the setting change related process, the program returns to S81 and repeats the process. Examples of the ending timing are a timing when the host vehicle finishes the autonomous driving without monitoring responsibility, the end of the waiting state, and the like.

### Sixth Embodiment

The present disclosure is not limited to the configurations of the foregoing embodiments and may employ the following configuration of a sixth embodiment. Hereinafter, an example of the configuration of the sixth embodiment will be described with reference to the drawings.

### (Schematic Configuration of System 1e for Vehicle)

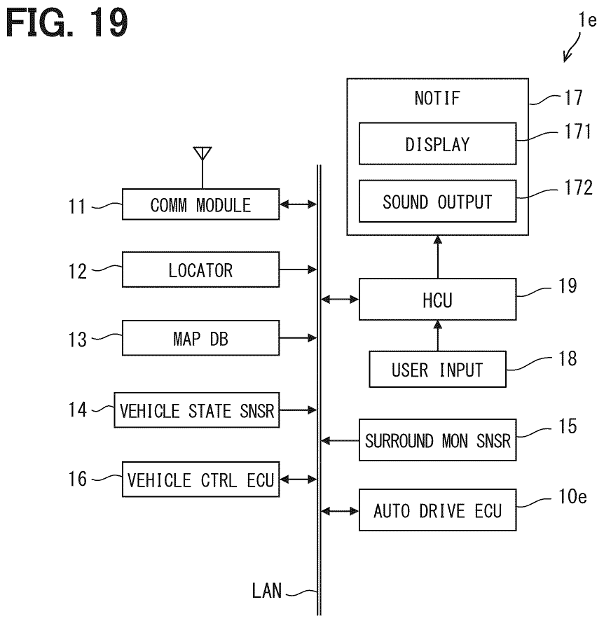

A system 1e for a vehicle illustrated in FIG. 19 can be used in an autonomous driving vehicle. As illustrated in FIG. 19, the system 1e for a vehicle includes an autonomous driving ECU 10e, the communication module 11, the locator 12, the map DB 13, the vehicle state sensor 14, the surrounding monitoring sensor 15, the vehicle control ECU 16, the notifying device 17, the user input device 18, and the HCU 19. The system 1e for a vehicle is similar to the system 1 for a vehicle of the first embodiment except for the point that the autonomous driving ECU 10e is included in place of the autonomous driving ECU 10.

### (Schematic Configuration of Autonomous Driving ECU 10e)

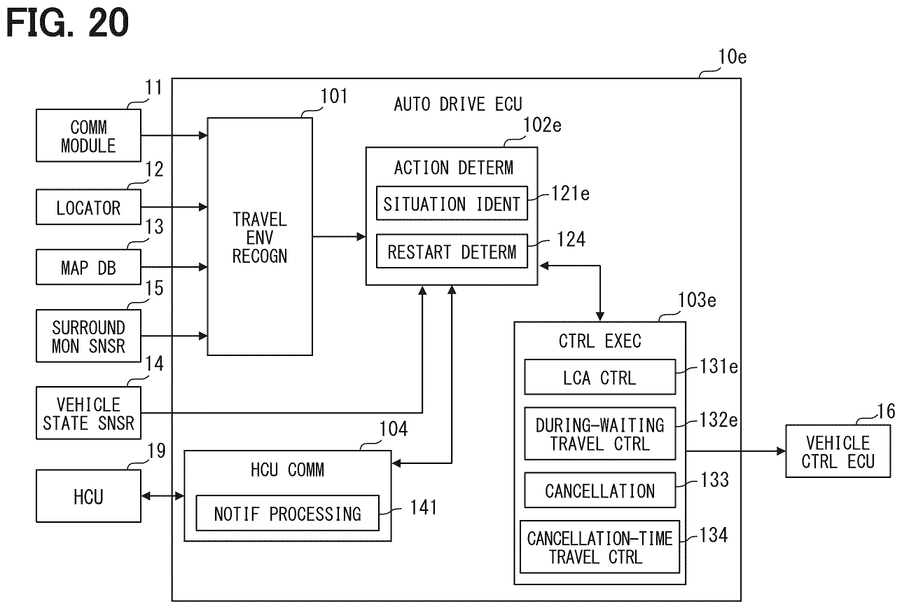

As illustrated in FIG. 20, the autonomous driving ECU 10e has the travel environment recognizing unit 101, an action determining unit 102e, a control executing unit 103e, and the HCU communication unit 104 as function blocks. The autonomous driving ECU 10e has the action determining unit 102e in place of the action determining unit 102. The autonomous driving ECU 10e has the control executing unit 103e in place of the control executing unit 103. The autonomous driving ECU 10e is similar to the autonomous driving ECU 10 of the first embodiment except for those points. The autonomous driving ECU 10e also corresponds to a vehicle control device. Execution of processes of the function blocks of the autonomous driving ECU 10e by a computer corresponds to execution of a vehicle control method.

The control executing unit 103e has an LCA control unit 131e, a during-waiting travel control unit 132e, the cancellation unit 133, and the cancellation-time travel control unit 134 as sub function blocks. The control executing unit 103e has the LCA control unit 131e in place of the LCA control unit 131. The control executing unit 103e has the during-waiting travel control unit 132e in place of the during-waiting travel control unit 132. The control executing unit 103e is similar to the control executing unit 103 of the first embodiment except for those points.

The LCA control unit 131e is similar to the LCA control unit 131 of the first embodiment except for the point that a part of the process is different. Hereinafter, the different point will be described. The LCA control unit 131e performs passing control for changing the lane to pass a preceding vehicle in the host vehicle lane. Hereinafter, a preceding vehicle as a passing object will be called a target preceding vehicle. In the passing control, a lane change in two stages is performed. The first stage is a lane change from the host vehicle lane to the adjacent lane. The second stage is a lane change to return to the original host vehicle lane after passing the target preceding vehicle in the adjacent lane.

The during-waiting travel control unit 132e is similar to the during-waiting travel control unit 132 in the first embodiment except for the point that a part of the process is different. The different point will be described in detail later. The action determining unit 102e has a situation identifying unit 121e and a restart determining unit 124 as sub function blocks. The situation identifying unit 121e is similar to the situation identifying unit 121 of the first embodiment except for the point that a part of the process is different. Hereinafter, the different point will be described.

In the case of executing the passing control, the situation identifying unit 121e identifies either a vehicle control that the host vehicle passes another vehicle is performed or a vehicle control that the host vehicle is passed by another vehicle is performed. The vehicle control that the host vehicle passes another vehicle will be called a first passing control. The vehicle control that another vehicle is allowed to pass the host vehicle will be called a later passing control. The first passing control is a passing control performed without waiting for another vehicle to pass the host vehicle. The later passing control is a passing control performed after another vehicle passes the host vehicle. The situation identifying unit 121e identifies which one of the first passing control and the later passing control is performed on the basis of the situation of a rearward vehicle in a lane as a lane change destination at the first stage. For example, in the case where distance from the rearward vehicle is long enough and the rearward vehicle is not approaching the host vehicle, it may be identified that the first passing control is executed. In the case where the distance from the rearward vehicle is not long enough and the rearward vehicle is approaching the host vehicle, it may be identified that the later passing control is executed.

The situation identifying unit 121e identifies a situation in which the later passing control to make another vehicle pass the host vehicle is performed but the another vehicle does not pass the host vehicle. Hereinafter, this situation will be called a no-reaction situation. The no-reaction situation may be set as a situation where time since the later passing control started reaches predetermined time but another vehicle does not pass the host vehicle. The predetermined time may be time which can be arbitrarily set. The start of the later passing control in this case may be, for example, the timing when a notification to start the passing control is made by the notifying device 17.

The during-waiting travel control unit 132e makes the host vehicle travel in the waiting state in the case where the first waiting situation is identified by the situation identifying unit 121e during the above-described passing control. The during-waiting travel control unit 132e changes the travel position of the host vehicle in the waiting state between the case where the situation of performing the first passing control is identified and the case where the situation of performing the later passing control is identified. Consequently, when the travel position of the host vehicle in a preferable waiting state varies between the first passing control and the later passing control, the host vehicle can be changed to the travel position according to the situation. As a result, the host vehicle can wait for a lane change in the passing control in the travel position according to the situation.

In the case where the situation identifying unit 121e identifies a situation of performing the first passing control, preferably, the during-waiting travel control unit 132e makes the host vehicle perform the following travel as a travel in the waiting state. The during-waiting travel control unit 132e once performs a lane change to the adjacent lane for passing and, after that, makes the host vehicle travel in the center of the adjacent lane. On the other hand, in the case where the situation identifying unit 121e identifies a situation of performing the later passing control, preferably, the during-waiting travel control unit 132e performs the following travel as a travel in the waiting state. The during-waiting travel control unit 132e makes the host vehicle travel while moving the host vehicle to an end part on the side to which the lane change is being performed in the host vehicle lane. Also in the case where the host vehicle crosses over the adjacent lane, the host vehicle is moved back to the original host vehicle lane and made travel in an end part on the side to which the lane change was being performed.

With the above configuration, in a situation where it is unnecessary to wait for another vehicle to pass the host vehicle, the lane change at the first stage is performed, and the host vehicle can wait for the lane change at the second stage in the lane as the destination of the lane change. On the other hand, in a situation where it is necessary to wait for another vehicle to pass the host vehicle, the host vehicle can wait for the lane change at the first stage in the host vehicle lane. In this case, the host vehicle is made travel while being moved to an end part on the side to which the lane change is being performed, so that the lane change can be promptly performed after another vehicle passes the host vehicle. The present disclosure is not limited to the above-described examples. As long as the travel position is according to the situation of the first passing control or the later passing control, the travel position in the waiting state may be another travel position.

When the above-described no-reaction situation is identified by the situation identifying unit 121e, preferably, the during-waiting travel control unit 132e continues the waiting state for predetermined time. Consequently, even in the case where a rearward vehicle in the destination of the lane change approaches suddenly, adjacency can be avoided more easily as compared with the case where the lane change is restarted immediately after the situation identifying unit 121e identifies the no-reaction situation. The predetermined time may be time which can be arbitrarily set.

In the case where the above-described no-reaction situation is identified by the situation identifying unit 121e, the restart determining unit 124 may determine whether the lane change to the adjacent lane to which the host vehicle was being moved is restarted or not. That is, whether the lane change is restarted or not is determined. The restart determining unit 124 may determine whether the lane change is restarted or not by using route guide information of the host vehicle and the degree of congestion in each of the lanes. As the route guide information of the host vehicle, it is sufficient to use a travel plan determined by the action determining unit 102. As the degree of congestion in each of lanes, it is sufficient to use the degree of congestion identified by the situation identifying unit 121e. The situation identifying unit 121e may identify the degree of congestion in each of the lanes on the basis of the sensing information obtained from the surrounding monitoring sensor 15. For example, when it is difficult to delay the lane change in the travel plan and the degree of congestion in the lane change destination is low, the restart determining unit 124 may determine to restart the lane change.

When restart of the lane change is determined by the restart determining unit 124, preferably, the LCA control unit 131e changes the vehicle speed of the host vehicle to be lower than that of a target another vehicle. The target another vehicle is another vehicle as a target which is allowed to pass the host vehicle in the later passing control. Hereinafter, the another vehicle will be called a target another vehicle. Preferably, the LCA control unit 131e changes the vehicle speed of the host vehicle to be lower than that of the target another vehicle and makes the host vehicle change the lane at the rear of the target another vehicle. The lane change corresponds to the lane change at the first stage in the passing control. With the above configuration, when the lane change of the host vehicle is necessary in the above-described no-reaction situation, the lane change can be performed at the rear of the target another vehicle.

### (Passing Waiting Related Process in Autonomous Driving ECU 10e)

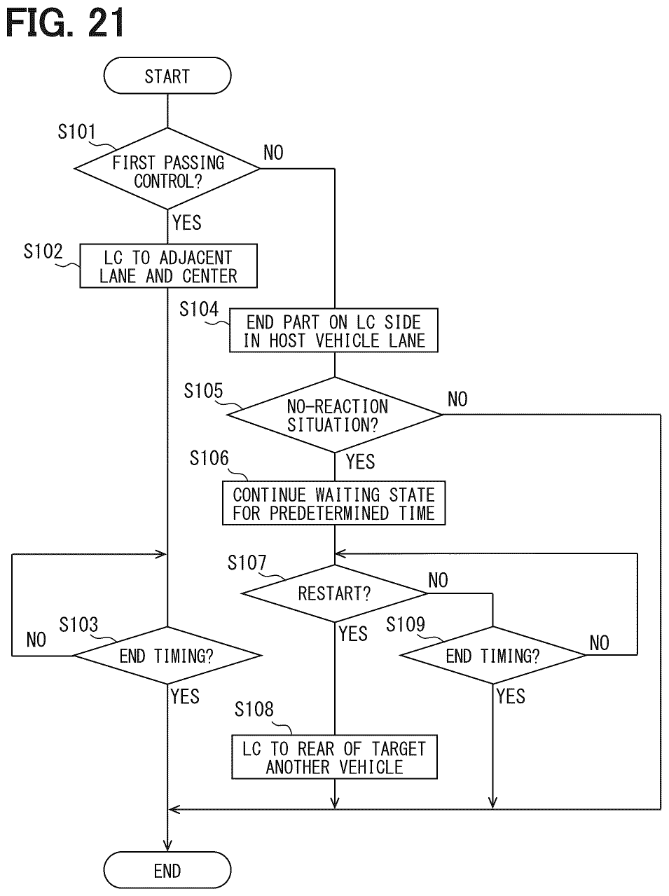

By referring now to the flowchart of FIG. 21, an example of the flow of process related to a waiting state in the passing control by the autonomous driving ECU 10e will be described. This process will be called a passing waiting related process. The flowchart of FIG. 21 may be started when the situation identifying unit 121 identifies the first waiting situation during execution of the passing control.

First, when the situation identifying unit 121e identifies that the passing control is the first passing control in step S101 (YES in S101), the program moves to step S102. On the other hand, when the situation identifying unit 121e identifies that the passing control is the later passing control (NO in S101), the program moves to step S104.

In step S102, the during-waiting travel control unit 132e once performs the lane change to the adjacent lane for passing and, after that, makes the host vehicle travel in the center of the adjacent lane. In FIG. 21, the lane change is expressed as LC. When it is the end timing of the passing waiting related process in step S103 (YES in S103), the passing waiting related process is finished. On the other hand, when it is not the end timing of the passing waiting related process (NO in S103), the process of S103 is repeated. Examples of the ending timing are a timing when the waiting state times out, the waiting state ends, and the like. The waiting state ends when continuation of the passing control becomes possible.

In step S104, the during-waiting travel control unit 132e makes the host vehicle travel while moving the host vehicle to an end part on the side to which the lane change was being performed in the host vehicle lane. When the no-reaction situation is identified by the situation identifying unit 121e in step S105 (YES in S105), the program moves to step S106. On the other hand, when the situation identifying unit 121e does not identify the no-reaction situation (NO in S105), the passing waiting related process is finished. When it is not the no-reaction situation, the target another vehicle passes the host vehicle. Consequently, the waiting state is solved, and the passing waiting related process is finished.

In step S106, the during-waiting travel control unit 132e continues the waiting state for predetermined time. When the restart determining unit 124 determines to restart the lane change to the adjacent lane to which the host vehicle was tried to be changed in step S107 (YES in S107), the program moves to step S108. On the other hand, when it is determined not to restart the lane change to the adjacent lane to which the host vehicle was tried to be changed (NO in S107), the program moves to step S109.

In step S108, the LCA control unit 131e changes the vehicle speed of the host vehicle to be lower than that of the target another vehicle, changes the host vehicle to the lane at the rear of the target another vehicle, and finishes the passing waiting related process. When it is the end timing of the passing waiting related process in step S109 (YES in S109), the passing waiting related process is finished. On the other hand, when it is not the end timing of the passing waiting related process (NO in S109), the program returns to S107 and repeats the process.

### Seventh Embodiment

Although the configurations that each of the autonomous driving ECUs 10, 10a, 10b, 10c, 10d, and 10e corresponds to a vehicle control device have been described in the foregoing embodiments, the present disclosure is not limited to them. For example, a configuration that an ECU other than the autonomous driving ECUs 10, 10a, 10b, 10c, 10d, and 10e corresponds to a vehicle control device may be also employed. For example, the HCUs 19, 19a, and 19b may bear the functions of the situation identifying units 121, 121a, 121d, and 121e, and the notification processing units 141, 141a, 141b, and 141c. In this case, each of the HCUs 19, 19a, and 19b corresponds to a vehicle control device. In this case, the HCUs 19, 19a, and 19b may bear the functions of the situation identifying units 121, 121a, 121d, and 121e by obtaining results identified by the situation identifying units 121 and 121a of the action determining unit 102. The functions of the autonomous driving ECUs 10, 10a, 10b, 10c, 10d, and 10e which are described in the above embodiments may be shared by the autonomous driving ECUs 10, 10a, 10b, 10c, 10d, and 10e and the HCUs 19, 19a, and 19b. In this case, a unit including the autonomous driving ECUs 10, 10a, 10b, 10c, 10d, and 10e and the HCUs 19, 19a, and 19b corresponds to a vehicle control device. The notification control units 141, 141a, 141b, 141c correspond to a notification control unit.

It should be noted that the present disclosure is not limited to the embodiments described above, and various modifications are possible within the scope indicated in the claims, and embodiments obtained by appropriately combining technical means disclosed in different embodiments are also included in the technical scope of the present disclosure. Further, the control unit and the method thereof described in the present disclosure may be implemented by a dedicated computer which includes a processor programmed to perform one or more functions executed by a computer program. Alternatively, the device and the method thereof described in the present disclosure may also be implemented by a dedicated hardware logic circuit. Alternatively, the device and the method thereof described in the present disclosure may also be implemented by one or more dedicated computers configured as a combination of a processor executing a computer program and one or more hardware logic circuits. The computer programs may be stored, as instructions to be executed by a computer, in a tangible non-transitory computer-readable storage medium.

What is claimed is:

1. A vehicle control device, which can be used in a vehicle performing autonomous driving without monitoring responsibility as autonomous driving without surrounding monitoring responsibility, comprising:
a situation identifying unit that is configured to identify a situation of the vehicle; and
a notification control unit that is configured to make a notification to inside of a compartment of the vehicle,
wherein
the situation identifying unit identifies, as the situation of the vehicle, a first waiting situation where an automatic lane change which was started has to be interrupted in middle and waited during the autonomous driving without monitoring responsibility, and
in a case where the situation identifying unit identifies the first waiting situation, the notification control unit makes a notification to notify of a waiting state in which the vehicle interrupts the lane change in the middle and is waiting, and a notification to notify of a cause of the waiting state.

2. The vehicle control device according to claim 1, wherein
in a case where the situation identifying unit identifies the first waiting situation, the notification control unit makes a notification to prompt surrounding monitoring to a driver of the vehicle even in the autonomous driving without monitoring responsibility.

3. The vehicle control device according to claim 1, further comprising
a cancellation unit that is configured to cancel the automatic lane change,
wherein
the situation identifying unit also identifies a takeover situation during waiting, in which driving takeover from the autonomous driving without monitoring responsibility to the driving with surrounding monitoring responsibility becomes necessary during the waiting state,
in a case where the takeover situation during waiting is identified by the situation identifying unit, the cancellation unit cancels the automatic lane change, and
in a case where the takeover situation during waiting is identified by the situation identifying unit, the notification control unit makes a notification to notify of cancellation of the automatic lane change and, subsequent to the notification, a notification to notify of the driving takeover.

4. The vehicle control device according to claim 1, wherein
in a case where the first waiting situation is identified by the situation identifying unit, the notification control unit performs a waiting state display indicating the waiting state as a notification to notify of the waiting state, in a display region in a display device performing display related to a second task as an action other than driving permitted to a driver of the vehicle.

5. The vehicle control device according to claim 4, wherein
in a case where the waiting state continues for designated time or longer, a timeout to finish the waiting state is performed, and
when the timeout is performed, the notification control unit finishes the waiting state display before the timeout, and makes a notification to notify that the timeout occurs in the waiting state at a timing deviated from the timing of finishing the waiting state display.

6. The vehicle control device according to claim 1, further comprising:
a time setting unit that is configured to change designated time of a timeout; and
an execution identifying unit that is configured to identify whether a driver is executing a second task as an action other than driving permitted to the driver of the vehicle,
wherein
in a case where the waiting state continues for designated time or longer, a timeout to finish the waiting state is performed, and
in the case the execution identifying unit identifies that the driver is executing a second task, the time setting unit changes the designated time to be longer than that in a case where it is identified that the driver is not executing a second task.

7. The vehicle control device according to claim 1, further comprising
an execution identifying unit that is configured to identify whether a driver is executing a second task as an action except for driving permitted to the driver of the vehicle,
wherein
the notification control unit controls also a notification regarding operation of a direction indicator of the vehicle to the inside of a compartment of the vehicle, and
in a case where the execution identifying unit identifies that the driver is executing a second task, the notification control unit suppresses a notification regarding operation of the direction indicator of the vehicle toward the inside of the compartment of the vehicle.

8. The vehicle control device according to claim 1, further comprising
a during-waiting travel control unit that is configured to make the vehicle travel in the waiting state in a case where the situation identifying unit identifies the first waiting situation.

9. The vehicle control device according to claim 8, wherein
in a case where the situation identifying unit identifies traffic congestion, as travel in the waiting state, the during-waiting travel control unit moves a travel position of the vehicle to an end part on the side to which the lane change of the vehicle was to be performed, in a travel lane of the vehicle more than that in a case where the traffic congestion is not identified, and makes the vehicle travel.

10. The vehicle control device according to claim 9, further comprising
a time setting unit that is configured to change designated time of a timeout,
wherein
a timeout for finishing the waiting state is performed in a case where the waiting state continues for designated time or longer, and
in a case where the situation identifying unit identifies traffic congestion, the time setting unit changes the designated time to be longer than that in a case where the traffic congestion is not identified.

11. The vehicle control device according to claim 9, further comprising
a distance setting unit that is configured to change a target distance between the vehicle and a preceding vehicle in a tracking travel control for maintaining the distance at a target distance,
wherein
the distance setting unit changes the target distance between the case where the situation identifying unit identifies traffic congestion in the travel lane of the vehicle and an adjacent lane as a destination of the lane change and the case where the situation identifying unit identifies traffic congestion in the travel lane of the vehicle and identifies no traffic congestion in the adjacent lane as a destination of the lane change.

12. The vehicle control device according to claim 11, wherein
in a case where the situation identifying unit identifies traffic congestion in the travel lane of the vehicle and identifies no traffic congestion in an adjacent lane as a destination of the lane change, the distance setting unit sets the target distance between vehicles to be longer than that in a case where the situation identifying unit identifies traffic congestion in the travel lane of the vehicle and the adjacent lane as a destination of the lane change.

13. The vehicle control device according to claim 9, further comprising
a time setting unit that is configured to change designated time of a timeout,
wherein
a timeout for finishing the waiting state is performed in a case where the waiting state continues for the designated time or longer, and
in a case where the state identifying unit identifies a situation that a surrounding monitoring sensor of the vehicle detects preceding and following vehicles in the travel lane of the vehicle, the time setting unit sets the designated time to be longer than that in a case where the situation identifying unit identifies a situation where the surrounding monitoring sensor cannot detect at least any of preceding and following vehicles in the travel lane of the vehicle.

14. The vehicle control device according to claim 8, wherein
the during-waiting travel control unit changes a travel position in the waiting state between the case where the situation identifying unit identifies a situation of performing a vehicle control in which the vehicle passes a different vehicle and the case where the situation identifying unit identifies a situation of performing a vehicle control in which a different vehicle is allowed to pass the vehicle.

15. The vehicle control device according to claim 14, wherein
in a case where the situation identifying unit identifies a situation of performing a vehicle control in which the vehicle passes a different vehicle, the during-waiting travel control unit performs a lane change once to an adjacent lane to which a lane change is performed for passing as the travel in the waiting state, after that, makes the vehicle travel in a center of the lane, and
in a case where the situation identifying unit identifies a situation of performing a vehicle control in which a different vehicle is allowed to pass the vehicle, the during-waiting travel control unit makes the vehicle travel while moving the vehicle to an end part on the side to which the lane change was to be performed in a travel lane of the vehicle as the travel in the waiting state.

16. The vehicle control device according to claim 14, wherein
in a case where the situation identifying unit identifies a situation where a vehicle control of allowing a different vehicle to pass the vehicle is executed but the different vehicle does not pass the vehicle, the during-waiting travel control unit continues the waiting state for predetermined time.

17. The vehicle control device according to claim 16, further comprising:
a restart determining unit that is configured to, in a case where the situation identifying unit identifies a situation where a vehicle control of allowing a different vehicle to pass the vehicle is executed but the different vehicle does not pass the vehicle, determine whether the lane change to an adjacent lane to which the vehicle was to be changed is restarted or not; and
a lane change control unit that is configured to, in a case where the restart determining unit determines to restart the lane change to the adjacent lane to which the vehicle was to be changed, change vehicle speed of the vehicle to be lower than that of the different vehicle, and make the vehicle change to the lane at a rear of the different vehicle.

18. The vehicle control device according to claim 8, wherein
the automatic lane change is performed after a travel position of the vehicle in a travel lane of the vehicle is moved to an end part on a side to which the lane change is performed, and
the during-waiting travel control unit moves the travel position of the vehicle to an end part side of the travel lane and makes the vehicle travel on a basis of a fact that the first waiting situation is identified by the situation identifying unit.

19. The vehicle control device according to claim 18, wherein
the vehicle control device can be used for a vehicle executing the autonomous driving without monitoring responsibility and the autonomous driving with monitoring responsibility as autonomous driving with the surrounding monitoring responsibility while switching the driving,
the situation identifying unit also identifies a second waiting situation in which in the autonomous driving with monitoring responsibility, after the automatic lane change starts, the lane change has to be interrupted in the middle and waited,
the during-waiting travel control unit makes the vehicle travel while moving the travel position of the vehicle to the end part side of the travel lane on a basis of the first waiting situation identified by the situation identifying unit, and
the during-waiting travel control unit moves the travel position of the vehicle back to a center of the travel lane and makes the vehicle travel in a case where the situation identifying unit identifies the second waiting situation.

20. The vehicle control device according to claim 18, wherein
in a case where the situation identifying unit identifies the first waiting situation and also the vehicle crosses over a compartment line on the side to which the lane change of the vehicle is to be performed in a travel lane, the during-waiting travel control unit moves the travel position of the vehicle back to the inside of the travel lane and makes the vehicle travel in an end portion side, and
in a case where the situation identifying unit identifies the first waiting situation and the vehicle does not cross over the compartment line on the side to which the lane change is to be performed in the travel lane, the during-waiting travel control unit moves the travel position of the vehicle back to a center of the travel lane and makes the vehicle travel.

21. The vehicle control device according to claim 19, wherein
the vehicle control device can be used for a vehicle executing the autonomous driving without monitoring responsibility and the autonomous driving with monitoring responsibility as autonomous driving with surrounding monitoring responsibility while switching the driving,
the situation identifying unit also identifies a second waiting situation in which in the autonomous driving with monitoring responsibility, after the automatic lane change starts, the lane change has to be interrupted in the middle and waited,
in a case where the situation identifying unit identifies the first waiting situation, the notification control unit makes a notification to notify of the waiting state and a notification to notify of a cause of the waiting state, and
in a case where the situation identifying unit identifies the second waiting situation, the notification control unit makes a notification to notify of the waiting state but does not make a notification to notify of the cause of the waiting state.

22. The vehicle control device according to claim 1, further comprising:
a cancellation unit that is configured to cancel an automatic lane change, the cancellation unit cancelling the automatic lane change when the situation identifying unit identifies the first waiting situation; and
a cancellation-time travel control unit that is configured to make the vehicle travel while moving a travel position of the vehicle to center of a travel lane of the vehicle when the automatic lane change is cancelled by the cancellation unit,
wherein
when the situation identifying unit identifies the first waiting situation, the notification control unit moves the travel position of the vehicle to the center of the travel lane by the cancellation-time travel control unit and, after that, makes a notification to notify of the waiting state and a notification to notify of a cause of the waiting state.

23. The vehicle control device according to claim 1, wherein
the notification control unit can make a notification by display in a display device and, at a time of a re-challenge to make the lane change performed again after the vehicle cannot complete the lane change, makes the display device which does not perform display related to the lane change before the re-challenge also perform display related to the lane change.

24. The vehicle control device according to claim 1, wherein
the notification control unit does not finish the notification to notify of a cause of the waiting state even when the cause of the waiting state is solved, and makes the notification continue until continuation time of the notification reaches predetermined time or until the lane change completes.

25. A vehicle control method, which can be used in a vehicle executing autonomous driving without monitoring responsibility as autonomous driving without surrounding monitoring responsibility, comprising:
a situation identifying step of identifying a situation of the vehicle; and
a notification control step of making a notification to an inside of a compartment of the vehicle,
steps being executed by at least one processor,
wherein
in the situation identifying step, a first waiting situation where an automatic lane change which was started has to be interrupted in a middle and waited during the autonomous driving without monitoring responsibility is identified as the situation of the vehicle, and
in the notification control step, in a case where the first waiting situation is identified in the situation identifying step, a notification to notify of a waiting state in which the vehicle interrupts the lane change in the middle and is waiting, and a notification to notify of a cause of the waiting state are made.

26. A vehicle control device, which can be used in a vehicle performing autonomous driving without monitoring responsibility as autonomous driving without surrounding monitoring responsibility, comprising:
a situation identifying unit that is configured to identify a situation of the vehicle; and
a notification control unit that is configured to make a notification to inside of a compartment of the vehicle,
wherein
the situation identifying unit identifies, as the situation of the vehicle, a first waiting situation where an automatic lane change which was started has to be interrupted in middle and waited during the autonomous driving without monitoring responsibility, and
in a case where the situation identifying unit identifies the first waiting situation, the notification control unit makes a notification to notify of a waiting state in which the vehicle interrupts the lane change in the middle and is waiting.

27. A vehicle control method, which can be used in a vehicle executing autonomous driving without monitoring responsibility as autonomous driving without surrounding monitoring responsibility, comprising:
a situation identifying step of identifying a situation of the vehicle; and
a notification control step of making a notification to an inside of a compartment of the vehicle,
steps being executed by at least one processor,
wherein
in the situation identifying step, a first waiting situation where an automatic lane change which was started has to be interrupted in a middle and waited during the autonomous driving without monitoring responsibility is identified as the situation of the vehicle, and
in the notification control step, in a case where the first waiting situation is identified in the situation identifying step, a notification to notify of a waiting state in which the vehicle interrupts the lane change in the middle and is waiting.
